(19) United States
(12) Patent Application Publication
(10) Pub. No.: US 2026/0288025 A1
(43) Pub. Date: Sep. 24, 2026

(54) TONER, DEVELOPING AGENT, TONER ACCOMMODATING UNIT, IMAGE FORMING APPARATUS, AND IMAGE FORMING METHOD

(71) Applicants: Daichi HISAKUNI, Kanagawa (JP); Takafumi KOYAMA, Kanagawa (JP); Shuto SUNAGA, Kanagawa (JP)

(72) Inventors: Daichi HISAKUNI, Kanagawa (JP); Takafumi KOYAMA, Kanagawa (JP); Shuto SUNAGA, Kanagawa (JP)

(21) Appl. No.: 19/542,670

(22) Filed: Feb. 18, 2026

(30) Foreign Application Priority Data
Mar. 18, 2025 (JP) 2025-043787

(51) Int. Cl. G03G 9/093; G03G 9/113

(52) U.S. Cl. CPC G03G 9/09342; G03G 9/1135

(57) ABSTRACT

A toner contains a toner base particle containing a core particle that contains a binder resin, a release agent, and a colorant, and fine resin particles disposed on the surface of the core particle, and an external additive containing zinc stearate particles, wherein the content of zinc in the toner is 0.05 to 0.60 percent by mass of the toner, and the content of fine zinc particles having a particle diameter of at most 20 m in the toner is at least 40 percent by mass of zinc in the toner.

### CROSS-REFERENCE TO RELATED APPLICATIONS

This patent application is based on and claims priority pursuant to 35 U.S.C. § 119 to Japanese Patent Application No. 2025-043787 filed on Mar. 18, 2025, in the Japan Patent Office, the entire disclosure of which is hereby incorporated by reference herein.

### BACKGROUND

### Technical Field

The present disclosure relates to a toner, a developing agent, a toner accommodating unit, an image forming apparatus, and an image forming method.

### Description of the Related Art

In recent years, toners have been required to have smaller particle sizes and improved high-temperature offset resistance for achieving higher output image quality, as well as low-temperature fixability for energy saving. As the power consumption during fixing constitutes a significant portion of the energy used in the image formation process, enhancing the low-temperature fixability is required.

To improve the low-temperature fixability of the toner, it is suitable to use a low-melting material in the toner. However, a toner produced using a low-melting material tends to have poor thermal storage stability, and also exhibits increased particle adhesion, which can lead to system-level issues such as cleaning failures due to toner adhesion onto the photoconductor or the cleaning blade.

### SUMMARY

The present disclosure described herein provides a toner that contains a toner base particle containing a core particle that contains a binder resin, a release agent, and a colorant, and fine resin particles disposed on the surface of the core particle, and an external additive containing zinc stearate particles, wherein the content of zinc in the toner is 0.05 to 0.60 percent by mass of the toner, and the content of fine zinc particles having a particle diameter of at most 20 μm in the toner is at least 40 percent by mass of zinc in the toner.

As another aspect of the present disclosure, a developing agent is provided which contains the toner mentioned above.

As another aspect of the present disclosure, a toner accommodating unit agent is provided which includes a toner accommodating container and the toner mentioned above contained in the tonner accommodating unit.

As another aspect of the present disclosure, an image forming apparatus is provided which includes an electrostatic latent image bearer, an electrostatic latent image forming device to form an electrostatic latent image on the electrostatic latent image bearer, and a developing device containing the toner mentioned above to develop the electrostatic latent image formed on the electrostatic latent image bearer to form a visible image with the toner mentioned above.

As another aspect of the present disclosure, an image forming method is provided which include forming an electrostatic latent image on an electrostatic latent image bearer and developing the electrostatic latent image formed on the electrostatic latent image bearer with the toner mentioned above.

### BRIEF DESCRIPTION OF THE SEVERAL VIEWS OF THE DRAWINGS

A more complete appreciation of the disclosure and many of the attended advantages and features thereof can be readily obtained and understood from the following detailed description with reference to the accompanying drawings wherein:

FIG. 1 is a schematic diagram illustrating an image forming apparatus;

FIG. 2 is a schematic diagram illustrating an example of a process cartridge; and

FIG. 3 is a diagram illustrating an example of the status of the presence of fine resin particles on the surface of the toner of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more the features, integers, steps, operations, elements, components, and/or groups thereof.

Embodiments of the present invention are described in detail below with reference to accompanying drawings. In describing embodiments illustrates in the drawings, specific terminology is employed for the sake of clarity. However, the disclosure of this patent specification is not intended to be limited to the specific terminology so selected. And it is to be understood that each specific element includes all technical equivalents that have a similar function, operates in a similar manner, and achieve a smaller result.

For the sake of simplicity, the same reference number will be given to identical constituent elements such as parts and materials having the same functions and redundant descriptions thereof omitted unless otherwise stated.

Within the context of the present disclosure, it a first layer is stated to be “overlaid” on, or “overlying” a second layer, the first layer may be in direct contact with a portion or all of the second layer, or there may be one or more intervening layers between the first and second layer, with the second layer being close to the substrate than the first layer.

The present disclosure provides a toner that achieves both excellent low-temperature fixability and thermal storage stability, and also exhibits superior cleaning performance for the image bearer.

Hereinafter, the toner, the developing agent, a toner accommodating unit, an image forming apparatus, and the image forming method of the present disclosure are described with reference to the accompanying drawings.

It is to be noted that the following embodiments are not limiting the present disclosure and any deletion, addition, modification, change, etc. can be made within a scope in which man in the art can conceive including other embodiments, and any of which is included within the scope of the present disclosure as long as the effect and feature of the present disclosure are demonstrated.

### Toner

The toner of the present disclosure includes toner base particles, fine zinc particles, and zinc stearate particles as an external additive, and may further optionally contain other components.

### Toner Base Particle

The toner base particles are made of core particles and fine resin particles disposed on the surfaces of the core particles. The core particles contain a binder resin, a release agent, and a colorant, and may further optionally contain other components.

### Fine Resin Particle

The fine resin particles are disposed on the surfaces of the core particles to coat the core particles. Coating the core particles with the fine resin particles improves the durability and thermal storage stability of the toner, and also. Prevents the zinc stearate particles from becoming embedded in the core particles.

The fine resin particles preferably include a core resin (core portion) and a shell resin (shell portion) that covers at least part of the surface of the core resin, and more preferably include vinyl-based units derived from the core resin and the shell resin.

### Shell Resin

There is no particular limitation on the shell resin, and it may be appropriately selected according to a particular application; however, polymers obtained by homopolymerization or copolymerization of vinyl monomers are preferable.

For example, vinyl polymers include the following (1) to (10).

### (1) Vinyl Hydrocarbons

Vinyl hydrocarbons include, for example, (1-1) aliphatic vinyl hydrocarbons, (1-2) alicyclic vinyl hydrocarbons, and (1-3) aromatic vinyl hydrocarbons.

### (1-1) Aliphatic Vinyl Hydrocarbon

Aliphatic vinyl hydrocarbons include, for example, alkenes and alkadienes.

Alkenes include, for example, ethylene, propylene, and alpha-olefins.

Alkadienes include, for example, butadiene, isoprene, 1,4-pentadiene, 1,6-hexadiene, and 1,7-octadiene.

### (1-2) Alicyclic Vinyl Hydrocarbon

Alicyclic vinyl hydrocarbons include, for example, mono-cycloalkenes, di-cycloalkenes, and di-alkadienes. Specific examples include, but are not limited to, (di)cyclopentadiene and terpenes.

### (1-3) Aromatic Vinyl Hydrocarbon

Examples of aromatic vinyl hydrocarbons include, but are not limited to, styrene and hydrocarbon-substituted derivatives of styrene (e.g., alkyl, cycloalkyl, aralkyl, alkenyl).

Specific examples of hydrocarbon-substituted derivatives of styrene include, but are not limited to, α-methylstyrene, 2,4-dimethylstyrene, and vinylnaphthalene.

### (2) Vinyl Monomer Containing Carboxyl Group and its Salts

The vinyl monomers containing carboxyl groups and their salts include, for example, unsaturated monocarboxylic acids (salts) and unsaturated dicarboxylic acids (salts) with carbon numbers ranging from 3 to 30, their anhydrides (salts), and monoalkyl (carbon number 1 to 24) esters.

Specific examples of vinyl monomers containing carboxyl groups include, but are not limited to, (meth)acrylic acid, (anhydrous) maleic acid, maleic acid monoalkyl esters, fumaric acid, fumaric acid monoalkyl esters, crotonic acid, itaconic acid, itaconic acid monoalkyl esters, itaconic acid glycol monoethers, citraconic acid, citraconic acid monoalkyl esters, and carboxyl group-containing vinyl monomers such as cinnamic acid, including their metal salts.

In the present disclosure, the term “(salt)” refers to an acid or a salt thereof. For example, the expression “unsaturated monocarboxylic acid (salt) having 3 to 30 carbon atoms” means an unsaturated monocarboxylic acid or a salt thereof.

Specific examples of the salts include, but are not limited to, alkali metal salts (sodium salts, potassium salts, etc.), alkali earth metal salts (calcium salts, magnesium salts, etc.), and ammonium salts, amine salts, quaternary ammonium salts.

In the present embodiment, “(meth)acrylic” means methacrylic acid or acrylic acid, “(meth)acryloyl” means methacryloyl or acryloyl, and “(meth)acrylate” means methacrylate or acrylate.
(3) Sulfonic Acid Group-containing Vinyl Monomers, Vinyl Sulfate Monoesters, and Salts Thereof Examples of the sulfonic acid group-containing vinyl monomers, vinyl sulfate monoesters, and salts thereof include, for example, alkanesulfonic acids (or salts) having 2 to 14 carbon atoms, alkylsulfonic acids (or salts) having 2 to 24 carbon atoms, sulfo(hydroxy)alkyl (meth)acrylates (or salts), (meth)acrylamides (or salts), and alkyl allyl sulfosuccinates (or salts).

Examples of alkanesulfonic acids (or salts) having 2 to 14 carbon atoms include, but are not limited to, vinylsulfonic acid (or salts).

Examples of alkylsulfonic acids (or salts) having 2 to 24 carbon atoms include, but are not limited to, α-methylstyrenesulfonic acid (or salts).

Examples of sulfo(hydroxy)alkyl (meth)acrylates (or salts) include, but are not limited to, sulfo(propyl)(meth)acrylates (or salts), sulfate esters (or salts), and sulfonic acid group-containing vinyl monomers (or salts).

### (4) Vinyl Monomer Having Phosphoric Group and its Salts

The vinyl monomers containing phosphoric acid groups and their salts include, for example, (meth)acryloyloxyalkyl (carbon number 1 to 24) phosphoric acid monoesters (salts), and (meth)acryloyloxyalkyl (carbon number 1 to 24) phosphonic acids (salts).

Specific examples of the (meth)acryloyloxyalkyl (carbon number 1 to 24) phosphoric acid monoesters (salts) include, but are not limited to, 2-hydroxyethyl (meth)acryloyloxyphosphate (salts), and phenyl-2-acryloyloxyethyl phosphate (salts).

Specific examples of the (meth)acryloyloxyalkyl (carbon number 1 to 24) phosphonic acids (salts) include 2-acryloyloxyethyl phosphonic acid and its salt.

### (5) Hydroxyl Group-Containing Vinyl Monomer

The hydroxyl group-containing vinyl monomers include, but are not limited to, hydroxystyrene, N-methacryloyl(meth)acrylamide, hydroxyethyl (meth)acrylate, hydroxypropyl (meth)acrylate, polyethylene glycol mono(meth)acrylate, (meth)allyl alcohol, crotyl alcohol, isocrotyl alcohol, 1-butene-3-ol, 2-butene-1-ol, 2-butene-1,4-diol, propargyl alcohol, 2-hydroxyethyl propenyl ether, and sucrose allyl ether,

### (6) Nitrogen-Containing Vinyl Monomer

The nitrogen-containing vinyl monomers include, but are not limited to, (6-1) amino group-containing vinyl monomers, (6-2) amide group-containing vinyl monomers, (6-3) nitrile group-containing vinyl monomers, (6-4) quaternary ammonium cation group-containing vinyl monomers, and (6-5) nitro group-containing vinyl monomers.

### (6-1) Amino Group-Containing Vinyl Monomer

One example of the amino group-containing vinyl monomers is aminoethyl (meth)acrylate.

### (6-2) Amide Group-Containing Vinyl Monomer

Specific examples include, but are not limited to, (meth)acrylamide and N-methyl (meth)acrylamide.

### (6-3) Nitrile Group-Containing Vinyl Monomer

Specific examples include, but are not limited to, (meth)acrylonitrile, cyanostyrene, and cyanoacrylate.

### (6-4) Quaternary Ammonium Cation Group-Containing Vinyl Monomer

Specific examples include, but are not limited to, quaternized derivatives of tertiary amine-containing vinyl monomers such as dimethylaminoethyl (meth)acrylate, diethylaminoethyl (meth)acrylate, dimethylaminoethyl (meth)acrylamide, diethylaminoethyl (meth)acrylamide, using quaternizing agents such as methyl chloride, dimethyl sulfate, benzyl chloride, and dimethyl carbonate.

### (6-5) Nitro Group-Containing Vinyl Monomers

One example of the nitro group-containing vinyl monomers is nitrostyrene.

### (7) Epoxy Group-Containing Vinyl Monomer

The epoxy-group-containing vinyl monomers include, but are not limited to, glycidyl (meth)acrylate, tetrahydrofurfuryl (meth)acrylate, and p-vinylphenylphenyl oxide.

### (8) Halogen Element-Containing Vinyl Monomer

The halogen element-containing vinyl monomers include, but are not limited to, vinyl chloride, vinyl bromide, vinylidene chloride, allyl chloride, chlorostyrene, bromostyrene, dichlorostyrene, chloromethylstyrene, tetrafluorostyrene, and chloroprene.

### (9) Vinyl Esters, Vinyl (Thio)Ether, and Vinyl Ketone

For vinyl esters, specific examples include, but are not limited to, vinyl acetate, vinyl butylate, vinyl propionate, vinyl butyrate, diarylphthalate, diaryladipate, isopropenyl acetate, vinylmethacrylate, methyl-4-vinylbenzoate, cyclohexylmethacrylate, benzylmethacrylate, phenyl(meth)acrylate, vinylmethoxyacetate, vinylbenzoate, ethyl-α-ethoxyacrylate, alkyl (having 1 to 50 carbon atoms)(meth)acrylate such as methyl(meth)acrylate, ethyl(meth)acrylate, propyl(meth)acrylate, butyl(meth)acrylate, 2-ethylhexyl(meth)acrylate, dodecyl(meth)acrylate, hexadecyl(meth)acrylate, heptadecyl(meth)acrylate, octadecyl(meth)acrylate, eicosyl(meth)acrylate), and behenyl(meth)acrylate, dialkyl fumalate (in which two alkyl groups are straight chained, branch chained, or cyclic chained groups and have 2 to 8 carbon atoms), poly(meth)aryloxyalkanes such as diaryloxyethane, triaryloxyethane, tetraaryloxyethane, tetraaryloxypropane, tetrapropoxybutane and tetramethyloxetane, vinyl monomers having polyalkylene glycol chain such as polyethylene glycol (molecular weight: 300) mono(meth)acrylate, polypropylene glycol (molecular weight: 500) monoacrylate, adducts of (meth)acrylate with 10 mol of methylalcoholethyleneoxide, and adducts of (meth)acrylate with 30 mol of lauryl alcohol ethylene oxide), poly(meth)acrylates such as poly(meth)acrylates of polyhydroxyl alcohols (e.g., ethylene glycol di(meth)acrylate, propylene glycol di(meth)acrylate, neopentylglycol di(meth)acrylate, trimethylol propane tri(meth)acrylate, and polyethylene glycol di(meth)acrylate).

One example of vinyl (thio)ether is vinyl methylether.

One example of vinyl ketone is vinyl methylketone.

### (10) Other Vinyl Monomer

Specific examples of the other vinyl monomers include, but are not limited to, tetrafluoroethylene, fluoroacrylate, isocyanatoethyl (meth)acrylate, and m-isopropenyl-α,α-dimethylbenzyl isocyanate.

The shell resin can be synthesized using the above-mentioned (1) to (10) vinyl monomers either individually or in combination of two or more.

As for the shell resin, copolymers of styrene with (meth)acrylic acid esters and copolymers of (meth)acrylic acid esters are preferable, with a preference to copolymers of styrene with (meth)acrylic acid esters to demonstrate good low-temperature fixability.

The loss modulus G′ of the viscoelastic properties of the shell resin at 100 degrees Celsius at a frequency of 1 Hz is not particularly limited and may be appropriately selected according to a particular application. A value of from 1.5 MPa to 100 MPa is preferred, a value of from 1.7 MPa to 30 MPa is more preferable, and a value of from 2.0 MPa to 10 MPa is particularly preferable.

The loss modulus G′ of the viscoelastic properties of the shell resin and the core resin described later at 100 degrees Celsius at a frequency of 1 Hz can be adjusted, for example, by changing the type and proportion of the constituent monomers, or by modifying the polymerization conditions (such as the types and amounts of the initiator and chain transfer agent, as well as the reaction temperature).

The acid value of the shell resin is not particularly limited and may be appropriately selected according to a particular application; a value of from 75 mgKOH/g to 400 mgKOH/g is preferable, and a value of from 150 mgKOH/g to 300 mgKOH/g is more preferable. When the acid value of the shell resin is from 75 to 400 mgKOH/g, fine resin particles containing vinyl-based units that include both the shell resin and the core resin as constituent components in the same particle tend to form a toner in which the fine resin particles are attached to the surfaces of the toner base particles.

The calculated acid value is the theoretical acid value derived from the molar quantity of the acidic groups contained in the constituent monomers and the total weight of the constituent monomers.

The shell resin preferably contains methacrylic acid and/or acrylic acid.

The content of methacrylic acid and/or acrylic acid is not particularly limited and may be appropriately selected according to a particular application; a content of from 10 to 60 percent by mass relative to the shell resin is preferable, and a content of from 30 to 50 percent by mass is more preferable. In this manner, the acid value of the shell resin can be set to from 75 to 400 mgKOH/g.

The glass transition temperature (Tg) of the shell resin is not particularly limited and may be appropriately selected according to a particular application; a Tg of from 0 to 150 degrees Celsius is preferable, and a Tg of from 50 to 100 degrees Celsius is more preferable. When the Tg is at least 0 degrees Celsius, excellent thermal storage stability is obtained. When the Tg is at most 150 degrees Celsius, excellent low-temperature fixability is achieved.

The glass transition temperature (Tg) of the shell resin is preferably higher than the glass transition temperature (Tg) of the core resin described later. As a result, a toner having excellent thermal storage stability is obtained.

To make the glass transition temperature (Tg) of the shell resin higher than that of the core resin described later, methods such as changing the type and proportion of the monomers used in synthesizing the shell resin may be employed.

The method of measuring the glass transition temperature (Tg) of the shell resin is not particularly limited and may be appropriately selected according to a particular application.

For example, the Tg may be measured using a DSC-60A (manufactured by Shimadzu Corporation) in accordance with the method specified in ASTM D3418-82 (DSC).

The melting point and the glass transition temperature of a target sample are measured in the following manner.

About 5.0 mg of a target sample is put in an aluminum sample container, which was then placed on a holder unit. Next, the unit and the container were disposed in an electric furnace. Then the unit and container are heated in a nitrogen atmosphere from 0 to 150 degrees Celsius at a temperature rising speed of 10 degrees Celsius/min (first temperature rising). Then the system is cooled down from 150 to 0 degrees Celsius at a temperature descending speed of 10 degrees Celsius/min, and reheated to 150 degrees Celsius C at a temperature rising speed of 10 degrees Celsius/min to measure a DSC curve using a difference scanning meter (DSC-60, available from Shimadzu Corporation.

Based on the DSC curve at the first temperature rising cycle selected from the obtained DSC curves using the analysis program “endothermic shoulder temperature” installed in the DSC-60 system, the glass transition temperature at the first temperature rising cycle of the target sample is obtained. The DSC curve at the second temperature rising cycle is selected using the analysis program “endothermic shoulder temperature” to obtain the glass transition temperature of the target sample at the second temperature rising.

Based on the DSC curve at the first temperature rising selected from the obtained DSC curves using the analysis program “endothermic peak temperature” installed in the DSC-60 system, the melting point of the first temperature rising cycle of the target sample is obtained. The DSC curve in the second temperature rising cycle is selected using the analysis program “endothermic peak temperature” to obtain the glass transition temperature of the target sample in the second temperature rising cycle.

The solubility parameter (SP) value of the shell resin is preferably from 9 to 13 (cal/cm³)^{1/2}, more preferably from 9.5 to 12.5 (cal/cm³)^{1/2}, and even more preferably from 10.5 to 11.5 (cal/cm³)^{1/2} for ease of toner particle formation.

The SP value of the shell resin can be adjusted by changing the types and proportions of the monomers constituting the shell resin.

The SP value may be calculated and determined according to the Fedors method [Polym. Eng. Sci. 14(2), 152 (1974)].

The number-average molecular weight (Mn) of the shell resin is not particularly limited and may be appropriately selected according to a particular application; a value of from 2,000 to 2,000,000 is preferred, and a value of from 20,000 to 200,000 is more preferred. When the number-average molecular weight is at least 2,000, the thermal storage stability is improved. When the number-average molecular weight is at most 2,000,000, the low-temperature fixability is improved.

The weight-average molecular weight (Mw) of the shell resin is not particularly limited and may be appropriately selected according to a particular application; the Mw is preferably greater than the weight-average molecular weight of the core resin described later, more preferably at least 1.5 times the Mw of the core resin, and particularly preferably at least 2.0 times the Mw of the core resin. This Mw facilitates the formation of the toner and provides excellent low-temperature fixability.

The weight average molecular weight (Mw) of the shell resin is preferably from 20,000 to 20,000,000 and more preferably from 200,000 to 2,000,000. When the weight-average molecular weight is at least 20,000, the thermal storage stability is improved. When the weight-average molecular weight is at most 20,000,000, low-temperature fixability is less inhibited.

The number average molecular weight (Mn) and the weight average molecular weight (Mw) is measurable with gel permeation chromatography (GPC), for example, under the following conditions:

### Measurement Conditions

An example of device: HLC-8120, available from TOSOH CORPORATION
An example of column: TSK GEL 6, available from TOSOH CORPORATION, two columns
Measuring temperature: 40 degrees Celsius
Sample solution: 0.25 percent by mass tetrahydrofuran solution (non-dissolved portion filtered with glass filter)
Amount of solution infused: 100 μL
Detector: Refractive index detector
Reference materials: Standard polystyrene (TSK standard polystyrene) with 12 materials (molecular weights: 500, 1,050, 2,800, 5,970, 9,100, 18,100, 37,900, 96,400, 190,000, 355,000, 1,090,000, and 2,890,000) (available from TOSOH CORPORATION)

### Core Resin

There is no particular limitation on the core resin, and it may be appropriately selected according to a particular application; polymers obtained by homopolymerization or copolymerization of vinyl monomers are preferable. Examples of the vinyl monomers used for the core resin include, for example, those similar to the vinyl monomers used for the shell resin.

As for the core resin, copolymers of styrene with (meth)acrylic acid esters and copolymers of (meth)acrylic acid esters are preferable, with a preference to copolymers of styrene with (meth)acrylic acid esters to demonstrate good low-temperature fixability.

The loss modulus G′ of the viscoelastic properties of the shell resin at 100 degrees Celsius at a frequency of 1 Hz is not particularly limited and may be appropriately selected according to a particular application. A value of from 0.01 to 1.0 MPa is preferred, a value of from 0.02 to 0.5 MPa is more preferable, and a value of from 0.05 to 0.3 MPa is particularly preferable.

When the loss modulus G′ of the viscoelastic properties is from 0.01 to 1.0 MPa, fine resin particles containing the shell resin and the core resin as constituent components within the same particle tend to form a toner in which the fine resin particles are attached to the surfaces of the toner base particles.

The acid value of the core resin is not particularly limited and can be appropriately selected according to a particular application. For example, a range of 0 to 50 mg/KOH is preferred, 0 to 20 mg/KOH is more preferred, and 0 mg/KOH is particularly preferred.

The glass transition temperature (Tg) of the core resin is not particularly limited and may be appropriately selected according to a particular application; a Tg of from −30 to 100 degrees Celsius is preferred, a Tg of from 0 to 80 degrees Celsius is more preferred, and a Tg of from 30 to 60 degrees Celsius is particularly preferred. When the Tg is at least −30 degrees Celsius, excellent thermal storage stability is obtained. When the Tg is at most 100 degrees Celsius, excellent low-temperature fixability is achieved.

The solubility parameter (SP) value of the core resin is preferably from 8.5 to 12.5 (cal/cm³)^{1/2} more preferably from 9 to 12 (cal/cm³)^{1/2}, and even more preferably from 10 to 11 (cal/cm³)^{1/2} for ease of toner particle formation.

The SP value of core resin can be adjusted by changing the types and proportions of the constituent monomers.

The number-average molecular weight (Mn) of the core resin is not particularly limited and may be appropriately selected according to a particular application; a value of from 1,000 to 1,000,000 is preferred, and a value of from 10,000 to 100,000 is more preferred. When the number-average molecular weight is at least 1,000, the thermal storage stability is improved. When the number-average molecular weight is at most 1,000,000, the low-temperature fixability is improved.

The weight-average molecular weight (Mw) of the core resin is not particularly limited and may be appropriately selected according to a particular application; a value of from 10,000 to 10,000,000 is preferred, and a value of from 100,000 to 1,000,000 is more preferred. When the weight-average molecular weight is at least 10,000, the thermal storage stability of toner is improved. When the weight-average molecular weight is at most 10,000,000, the low-temperature fixability is improved.

### Volume Average Particle Diameter of Fine Resin Particle

The volume average particle diameter of the fine resin particles is not particularly limited and can be suitably selected according to a particular application. For example, it is preferably from 10 to 60 nm and more preferably from 10 to 40 nm. When the volume-average particle diameter is at least 10 nm, good cleaning performance can be obtained while ensuring low-temperature fixability.

As for the method of measuring the volume-average particle diameter, it may be measured, for example, by observing and photographing an SEM image using a scanning electron microscope (SEM), and then measuring the particle diameter from the captured SEM image.

### Glass Transition Temperature (Tg) of Fine Resin Particle

The glass transition temperature (Tg) of the fine resin particle has no particular limitation and can be suitably selected according to a particular application. It is preferably from 40 to 70 degrees Celsius. When the glass transition temperature Tg is 40 to 70 degrees Celsius, high thermal storage stability can be ensured without inhibiting the fixing performance of the toner. Examples of methods for adjusting the glass transition temperature Tg to be from 40 to 70 degrees Celsius include appropriately adjusting the glass transition temperatures of the shell resin and the core resin.

As a method of measuring the glass transition temperature Tg of the fine resin particles, the fine resin particles present on the toner surface is measurable after they are physically peeled off or separated using an organic solvent.

### Mass Ratio Between Shell Resin and Core Resin in Fine Resin Particle

The mass ratio between the shell resin and the core resin in the fine resin particles is not particularly limited and can be suitably selected according to a particular application; a ratio of 5/95 to 95/5 is preferred, 25/75 to 75/25 is more preferred, and 40/60 to 60/40 is particularly preferred. When the mass ratio is at least 5/95, the toner exhibits excellent thermal storage stability. When the mass ratio is at most 95/5, the fine resin particles readily form a toner in which the fine resin particles are attached to the surfaces of the toner base particles.

### Method of Producing Resin Particle

Methods of producing fine resin particles include known manufacturing techniques, for example, the following methods (I) through (V):
(I) A method in which fine particles of the shell resin in an aqueous dispersion are used as seeds, and the monomers constituting the core resin are seed-polymerized.
(II) A method in which fine particles of the core resin in an aqueous dispersion are used as seeds, and the monomers constituting the shell resin are seed-polymerized.
(III) A method in which a mixture of the shell resin and the core resin is emulsified in an aqueous medium to obtain an aqueous dispersion of fine resin particles.
(IV) A method in which a mixture of the monomers constituting the shell resin and those constituting the core resin is emulsified in an aqueous medium, followed by polymerizing the monomers constituting the core resin to obtain an aqueous dispersion of fine resin particles.
(V) A method in which a mixture of the monomers constituting the core resin and those constituting the shell resin is emulsified in an aqueous medium, followed by polymerizing the monomers constituting the shell resin to obtain an aqueous dispersion of fine resin particles.

The presence of both the shell resin and the core resin as constituent components within the same particle can be confirmed by observing elemental-mapping images of cross-sections of the fine resin particles using known surface elemental analysis instruments (such as TOF-SIMS or EDX-SEM), and by observing electron micrographs of cross-sections of the fine resin particles stained with staining agents selected according to the functional groups contained in the shell resin and the core resin.

In some cases, the fine resin particles obtained by this method may be obtained as a mixture containing, in addition to fine resin particles that contain the shell resin and the core resin as constituent components within the same particle, fine resin particles made only of the shell resin and fine resin particles made only of the core resin. In the compounding process described later, the mixture may be used as-is, or only the fine resin particles may be isolated and used.

Specific examples of the method (I) include a method in which the monomers constituting the shell resin are dropwise polymerized to produce an aqueous dispersion of fine resin particles containing the shell resin, followed by seed-polymerizing the monomers constituting the core resin using the aqueous dispersion as seeds; and a method in which a shell resin previously produced by solution polymerization is emulsified and dispersed in water, followed by seed-polymerizing the monomers constituting the core resin using this as seeds.

Specific examples of the method (II) include a method in which the monomers constituting the core resin are drop-polymerized to produce an aqueous dispersion of fine resin particles containing the core resin, followed by seed-polymerizing the monomers constituting the shell resin using this aqueous dispersion as seeds; and a method in which a core resin previously produced by solution polymerization is emulsified and dispersed in water, followed by seed-polymerizing the monomers constituting the shell resin using this as seeds.

Specific examples of the method (III) include a method in which a solution or melt of a shell resin and a core resin previously produced by solution polymerization is mixed, followed by emulsifying and dispersing the mixture in an aqueous medium.

Specific examples of the method (IV) include a method in which a shell resin previously produced by solution polymerization is mixed with the monomers constituting the core resin, followed by emulsifying and dispersing the mixture in an aqueous medium and then polymerizing the monomers constituting the core resin; and a method in which the shell resin is produced in the monomers constituting the core resin, followed by emulsifying and dispersing the resulting mixture in an aqueous medium and then polymerizing the monomers constituting the core resin.

Specific examples of the method (V) include a method in which a core resin previously produced by solution polymerization is mixed with the monomers constituting the shell resin, followed by emulsifying and dispersing the mixture in an aqueous medium and then polymerizing the monomers constituting the shell resin; and a method in which the core resin is produced in the monomers constituting the shell resin, followed by emulsifying and dispersing the resulting mixture in an aqueous medium and then polymerizing the monomers constituting the shell resin.

### Binder Resin

As the binder resin, any resin known for use in toners may be employed; in order to exhibit more excellent low-temperature fixability, it is preferable to use a polyester resin, and it is more preferable to use two types of amorphous polyester resins, at least one of which has a urethane bond and a urea bond. Such a urethane bond or a urea bond behaves like a pseudo-crosslinking point, thereby enhancing rubber-like properties and further improving the thermal storage stability and high-temperature offset resistance of the toner. The composition of the polyester resin may be appropriately varied, and may also be selected in consideration of affinity with pigments and release agents such as waxes described later.

Examples of monomers for the polyester resin include, for example, diol components and dicarboxylic acid components.

### Diol Component

The diol components are not particularly limited and can be suitably selected according to a particular application.

Specific examples include, but are not limited to, aliphatic diols such as ethylene glycol, 1,2-propylene glycol, 1,3-propylene glycol, 1,4-butanediol, 2-methyl-1,3-propane diol, 1,5-pentanediol, 1,6-hexanediol, 1.8-octanediol, 1,10-decanediol, and 1,12-dodecanediol; diols having oxyalkylene groups such as diethylene glycol, triethylene glycol, dipropylene glycol, polyethylene glycol, polypropylene glycol and polytetramethylene ether glycol; alicyclic diols such as 1,4-cyclohexane dimethanol and hydrogenated bisphenol A; adducts of alicyclic diols with an alkylene oxide such as ethylene oxide, propylene oxide, and butylene oxide; bisphenols such as bisphenol A, bisphenol F, and bisphenol S; and adducts of bisphenols with an alkylene oxide such as ethylene oxide, propylene oxide, and butylene oxide. Among these, aliphatic diols with 4 to 12 carbon atoms are preferable.

These diols can be used alone or in combination.

### Dicarboxylic Acid Component

The dicarboxylic acid component is not particularly limited and can be suitably selected according to a particular application. It includes an aliphatic dicarboxylic acid and an aromatic dicarboxylic acid, for example. Their anhydrides, lower (1 to 3 carbon atoms) alkylester compounds, or halogenated compounds can be also used.

The aliphatic dicarboxylic acids are not particularly limited and can be suitably selected according to a particular application. Specific examples include, but are not limited to, succinic acid, adipic acid, sebacic acid, dodecanedioic acid, maleic acid, and fumaric acid.

The aromatic dicarboxylic acids are not specifically restricted and can be chosen as needed for the purpose. It is preferably aromatic dicarboxylic acids with 8 to 20 carbon atoms.

For aromatic dicarboxylic acids with 8 to 20 carbon atoms, there are no specific restrictions, and they can be chosen as needed for the purpose. Examples include, but are not limited to, phthalic acid, isophthalic acid, terephthalic acid, and naphthalenedicarboxylic acid.

Among these, aliphatic dicarboxylic acids with 4 to 12 carbon atoms are preferable.

These dicarboxylic acids can be used alone or in combination.

### Branching Component and Crosslinking Component

As monomers for the polyester resin, branching components and cross-linking components may be contained for the purpose of controlling melt properties.

Specific examples of the branching components and crosslinking components used as monomer components include, but are not limited to, polyfunctional aliphatic alcohols such as trimethylolpropane and pentaerythritol, polyfunctional carboxylic acids such as trimellitic acid, and isocyanurates that are trimers of hexamethylene diisocyanate.

### Crystalline Polyester Resin

It is preferable that the binder resin contain a crystalline polyester resin (hereinafter also referred to as “crystalline polyester”). When a crystalline polyester resin is contained, both low-temperature fixability and thermal storage stability can be achieved.

The monomers used for producing the crystalline polyester are not particularly limited and may be appropriately selected according to a particular application. For example, the diol components and dicarboxylic acid components described above are usable.

From the standpoint of low-temperature fixability, the melting point of the crystalline polyester resin is preferably from 60 to 120 degrees Celsius.

It is preferable that the crystalline polyester contain only a small amount of residual monomers and oligomers.

The weight-average molecular weight of the crystalline polyester is preferably at least 10,000. Although there is no particular upper limit for the polymerization-average molecular weight, values of at most 35,000 are preferred from the perspective of ease of production.

The method of incorporating the crystalline polyester resin into the toner is not particularly limited and may be appropriately selected according to a particular application. In general, examples include a method in which the crystalline polyester resin is mechanically pulverized and dispersed by an instrument such as a beads mill and then introduced in the form of a dispersion.

The content of the polyester resin is preferably at least 90 percent by mass relative to the total amount of the binder resin. The upper limit of the polyester resin content is preferably 100 percent by mass. The polyester resin refers to both crystalline polyester and amorphous polyester. Accordingly, in a toner containing both crystalline polyester and amorphous polyester, the content of the polyester resin refers to the total of the crystalline polyester content and the amorphous polyester content.

A polyester resin having a content of at least 90 percent by mass improves low-temperature fixability.

### Amorphous Hybrid Resin

In the present disclosure, it is preferable that the toner contain at least one resin selected from the group consisting of (i) composite resins containing a condensation-polymerization resin and a styrene-based resin, and (ii) an amorphous hybrid resin wherein two polymer components having independent reaction pathways are partially chemically bonded to each other, and at least one of the two polymer components is made of the same polymeric resin component as the polyester resin. In this configuration, dispersibility of the crystalline polyester resin within the toner is improved. In addition, the exposure of the crystalline polyester on the toner surface is controlled and the crystalline polyester uniformly dispersed within the toner strikes a balance between low-temperature fixability and thermal storage stability of the toner.

It is also preferable to obtain a resin by mixing a monomer (dual-reactive monomer) that can react with both of the raw-material monomers for the two polymerization resin components, in addition to a mixture of monomers that are raw materials for the two polymer components having independent reaction pathways.

Preferably, a dual-reactive monomer has at least one functional group selected from hydroxyl, carboxyl, epoxy, primary amino, and secondary amino groups, and has an ethylenically unsaturated bond; the use of such monomers enhances the dispersibility of the resin serving as the dispersed phase.

Specific examples of dual-reactive monomers include, but are not limited to, acrylic acid, fumaric acid, methacrylic acid, citraconic acid, and maleic acid, among which acrylic acid, methacrylic acid, and fumaric acid are preferred.

The amount of the dual-reactive monomer is preferably 0.1 to 10 parts by mass per 100 parts by mass of raw-material monomers for the condensation-polymerization resin. In the present embodiment, due to the peculiarity of its performance, the dual-reactive monomer is treated as a monomer separate from the raw-material monomers for the condensation-polymerization resin and those for the addition-polymerization resin.

In the present embodiment, to obtain the hybrid resin by performing the two polymerization reactions using the above raw-material monomer mixture together with the dual-reactive monomer, it is not necessary that the progression and completion of the reactions occur at the same time; the reaction temperature and time may be selected in accordance with each reaction mechanism to allow the reactions to proceed and be completed.

For example, in the method of producing the hybrid resin in the present embodiment, raw-material monomers for the condensation-polymerization resin, raw-material monomers for the addition-polymerization resin, the dual-reactive monomer, and catalysts such as polymerization initiators are mixed; first, an addition-polymerization resin component having a functional group capable of undergoing a condensation reaction is obtained mainly by radical polymerization at 50 to 180 degrees Celsius, and subsequently, after raising the reaction temperature to 190 to 270 degrees Celsius, the condensation-polymerization resin component is formed mainly by a condensation reaction.

The softening point of the amorphous hybrid resin is preferably 80 to 170 degrees Celsius, more preferably 90 to 160 degrees Celsius, and particularly preferably 95 to 155 degrees Celsius.

There is no particular limitation on the mass ratio of the crystalline polyester resin to the amorphous hybrid resin; a ratio of polyester resin to amorphous hybrid resin of 50/100 to 200/100 is preferred.

As the raw-material monomers for the condensation-polymerization resin, it is preferable that a succinic-acid-based derivative be used as the carboxylic acid component.

As the raw-material monomers for the styrene-based resin, styrene, α-methylstyrene, vinyltoluene, and other styrene derivatives are used.

The content of the styrene derivatives in the raw-material monomers for the styrene-based resin is preferably at least 50 percent by mass, more preferably at least 70 percent by mass, and still more preferably at least 80 percent by mass.

Raw-material monomers for the styrene-based resin that may be used in addition to the styrene derivatives include, but are not limited to, alkyl esters of (meth)acrylic acid; ethylenically unsaturated mono-olefins such as ethylene and propylene; diolefins such as butadiene; halovinyl compounds such as vinyl chloride; vinyl esters such as vinyl acetate and vinyl propionate; esters of ethylenically unsaturated monocarboxylic acids such as dimethylaminoethyl (meth)acrylate; vinyl ethers such as vinyl methyl ether; vinylidene halides such as vinylidene chloride; and N-vinyl compounds such as N-vinylpyrrolidone.

Among these, alkyl esters of (meth)acrylic acid are preferred from the perspective of low-temperature fixability and charge stability of the toner. The carbon number of the alkyl group in the alkyl ester of (meth)acrylic acid is preferably 1 to 22, more preferably 8 to 18, from the viewpoints described above. The carbon number of the alkyl ester refers to the number of carbon atoms derived from the alcohol component forming the ester.

Specific examples include, but are not limited to, methyl (meth)acrylate, ethyl (meth)acrylate, (iso)propyl (meth)acrylate, 2-hydroxyethyl (meth)acrylate, (iso- or tertiary-)butyl (meth)acrylate, 2-ethylhexyl (meth)acrylate, (iso)octyl (meth)acrylate, (iso)decyl (meth)acrylate, and (iso)stearyl (meth)acrylate.

The content of the alkyl ester of (meth)acrylic acid in the raw-material monomers for the styrene-based resin is preferably at most 50 percent by mass, more preferably at most 30 percent by mass, and still more preferably at most 20 percent by mass, from the viewpoints of toner low-temperature fixability, storability, and charge stability.

The content of the hybrid resin is not particularly limited and may be selected according to a particular application; it is preferable that the content be at least 15 percent by mass relative to the amount of the crystalline polyester.

When the content is less than 15 percent by mass, the effect of internally dispersing the crystalline polyester becomes weak, and the crystalline polyester may be excessively present on the toner surface.

### Content (Proportion) of Binder Resin

The content of the binder resin is not particularly limited and may be appropriately varied; for example, it is preferable that the binder resin be contained in an amount of 10 to 95 percent by mass in the toner base particles. Within this range, a toner having excellent fixing properties and charging performance is obtained.

### Colorant

Specific examples of the colorant include, but are note limited to, conventionally known dyes and pigments such as carbon black, lamp black, iron black, aniline blue, phthalocyanine blue, phthalocyanine green, hansa yellow G, rhodamine 6C lake, calco oil blue, chrome yellow, quinacridone, benzidine yellow, rose bengal, and triarylmethane dyes. These can be used alone or in combination. They can be used as black toner or full color toner.

The proportion of the colorant to the binder resin component of the toner is preferably from 1 to 30 percent by mass and more preferably from 3 to 20 percent by mass.

### Release Agent

As the release agent, there is no particular limitation, and it may be appropriately selected according to a particular application. Examples include, but are not limited to, carbonyl group-containing waxes, polyolefin waxes, and long-chain hydrocarbons. These can be used alone or in combination. Among these waxes, the waxes including a carbonyl group are particularly preferable.

Specific examples of the waxes including a carbonyl group include, but are not limited to, polyalkane acid ester, polyalkanol ester, polyalkane acid amide, polyalkyl amide, and dialkyl ketone.

Specific examples of the polyalkane acid esters include, but are not limited to, carnauba wax, montan wax, trimethylol propane tribehenate, pentaerythritol tetrabehenate, pentaerythritol diacetate dibehenate, glycerin tribehenate, and 1,18-octadecanediol distearate.

Specific examples of the polyalkanol esters include, but are not limited to, trimellitic acid tristearyl and distearyl maleate.

One specific example of the polyalkane acid amide is dibehenyl amide.

One specific example of the polyalkyl amide is trimellitic acid tristearyl amide.

One specific example of the dialkyl ketone is distearyl ketone.

Among these waxes containing a carbonyl group, polyalkane acid esters are particularly preferable.

Specific examples of the polyolefine waxes include, but are not limited to, polyethylene waxes and polypropylene waxes. Specific examples of the long-chain hydrocarbons include, but are not limited to, paraffin wax and sazol wax.

The melting point of the release agent is not particularly limited and can be suitably selected according to a particular application. The melting point is preferably from 50 to 100 degrees Celsius and more preferably from 60 to 90 degrees Celsius. When the melting point is 50 to 100 degrees Celsius, the following issues can be prevented: adverse effects on heat-resistance storage stability; and cold offset during fixing at low temperatures.

The melting point of the release agent can be measured by a differential scanning calorimeter (for example, TA-60WS or DSC-60, manufactured by Shimadzu Corporation).

First, place 5.0 mg of the release agent in an aluminum sample container, set the sample container on a holder unit, and set them in an electric furnace. Next, raise the temperature in nitrogen atmosphere from 0 to 150 degrees Celsius at a temperature rising speed of 10 degrees Celsius/min. Thereafter, drop the temperature from 150 to 0 degrees Celsius at a temperature falling speed of 10 degrees Celsius/min. Then raise the temperature in nitrogen atmosphere from 0 to 150 degrees Celsius at a temperature rising speed of 10 degrees Celsius/min. Again to plot a differential scanning calorimetry (DSC) curve. Using an analysis program installed in the DSC-60 system, determine the maximum peak temperature of the melting heat during the second temperature rising as the melting point from the obtained DSC curve.

The release agent preferably has a melt viscosity of from 5 to 100 mPa·sec, more preferably from 5 to 100 mPa·sec, and even more preferably from 5 to 20 mPa·sec at 100 degrees Celsius measurement. When the melt viscosity is lower than 5 mPa·sec, the releasing property may deteriorate. When the melt viscosity is greater than 100 mPa·sec, the effect of improving hot offset resistance and low temperature fixing property may be reduced.

The content of the aqueous resin is preferably from 3 to 15 parts by mass and more preferably from 3 to 13 parts by mass per 100 parts by mass of the toner. When the proportion is from 3 to 15 percent by mass, the following issues can be prevented:
a decrease in hot-offset resistance; and
a decrease in thermal storage stability, and filming in which the toner adheres to a carrier, photoconductor, or a blade.

### Other Optional Components

As for the other components, there is no particular limitation as long as they are those commonly used in toners, and they may be appropriately selected according to a particular application. Examples include, for example, charge control agents.

### Charge Control Agent

The charge control agent is not particularly limited and can be suitably selected according to a particular application. Specific examples include, but are not limited to, nigrosine dyes, triphenylmethane dyes, chrome containing metal complex dyes, chelate pigments of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing surfactants, metal salts of salicylic acid, and metal salts of salicylic acid derivatives. Specific examples include, but are not limited to, BONTRON 03 (nigrosine dye), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are available from Orient Chemical Industries Co., Ltd.; TP-302 and TP-415 (molybdenum complex of quaternary ammonium salt), which are available from Hodogaya Chemical Co., Ltd.; LRA-901, and LR-147 (boron complex), which are available from Japan Carlit Co., Ltd.

The proportion of the charge control agent is not particularly limited and can be suitably selected according to a particular application. The number of parts of the colorant is preferably from 0.01 to 5 parts by mass and more preferably from 0.02 to 2 parts by mass per 100 parts by mass of the toner. When the proportion is from 0.01 to 5 percent by mass, the following issues can be prevented:
insufficient charge rise properties or insufficient charge amount, which adversely affects the toner image; and
excessive chargeability of the toner, which increases the electrostatic attraction to the developing roller and results in decreased flowability of the developing agent or reduced image density.

### Zinc Stearate Particle

The toner according to one embodiment of the present disclosure contains zinc stearate particles as an external additive.

The zinc content is 0.05 to 0.60 percent by mass based on the total amount of the toner, and is preferably 0.09 to 0.20 percent by mass. When the zinc content is less than 0.05 percent, the coating effect on the photoconductor and other members is reduced, resulting in degraded cleaning performance and an increased wear rate of the image bearer. When the zinc content exceeds 0.60 percent, carrier spent and a decrease in chargeability occur.

The zinc content in the toner can be measured using a fluorescent X-ray instrument (ZSX-100e, manufactured by Rigaku Corporation).

Specifically, 3 g of toner is pelletized into a pellet having a diameter of 3 mm and a thickness of 2 mm using an automatic compression molding machine (T-BRB-32, manufactured by Maekawa; load: 6.0 t, pressing time: 60 seconds).

The resulting pellet is then analyzed with the fluorescent X-ray instrument (ZSX-100e, manufactured by Rigaku Corporation) to measure the zinc content (percent by mass) contained in the toner.

The content of fine zinc present in the toner as fine zinc particles having a particle diameter of at most 20 μm is at least 40 percent by mass of zinc in the toner and may be 100 percent by mass based on the total amount of zinc in the toner; however, from the viewpoint of charge stability, at most 60 percent by mass is more preferable. When the content of the fine zinc particles is less than 40 percent by mass, the coating effect on the photoconductor and other members is reduced, resulting in degraded cleaning performance and an increased wear rate of the image bearer.

The content of the fine zinc particles in the toner is preferably at least 0.03 percent by mass of the total amount of the toner, and, more preferably, from 0.04 to 0.25 percent buy mass.

The content of the fine zinc particles can be measured by, for example, the following method.

Into a 500-mL beaker, 10 g of polyoxyalkylene alkyl ether (Neugen ET-165, manufactured by Dai-Ichi Kogyo Seiyaku Co., Ltd.) and 300 mL of purified water are placed, and dispersion is performed by applying ultrasonic waves for 1 hour to obtain Dispersion A. Subsequently, Dispersion A is transferred into a 2-L volumetric flask and made up to the mark with purified water, and ultrasonic waves are applied for 1 hour to dissolve the contents, thereby obtaining Dispersion B containing 0.5 percent polyoxyalkylene alkyl ether.

Fifty milliliters of Dispersion B is poured into a 110-mL screw tube, and 3.75 g of the toner serving as the sample (referred to as sample toner prior to treatment) is added. While minimizing rotation to avoid foaming, the mixture is stirred for 30 to 90 minutes until the screw tube becomes wetted with Dispersion B, thereby obtaining Dispersion C.

Using an ultrasonic homogenizer (trade name: homogenizer, model VCX750/CV33, manufactured by Sonics & Materials Yugen Kaisha (Y.K.)), the vibrating portion is inserted 2.5 cm into Dispersion C, and ultrasonic vibration is applied for 1 minute at an output energy of 40 percent and a continuous amplitude of 40 W to obtain Dispersion D.

Dispersion D is placed in a 50-mL centrifuge tube and centrifuged at 2,000 rpm for 2 minutes to obtain a supernatant and a precipitate. The obtained precipitate is poured into a separatory funnel while being washed with 60 mL of purified water, and the wash water is removed by suction filtration.

The filtered precipitate and 60 mL of purified water are placed in a cup, stirred gently five times with the handle of a spatula, and the wash water is removed by suction filtration.

The toner remaining on the filter paper is collected and dried in a thermostatic chamber at 40 degrees Celsius for 8 hours. Three grams of the dried toner is pelletized into a pellet having a diameter of 3 mm and a thickness of 2 mm using an automatic compression molding machine (T-BRB-32, manufactured by Maekawa; load: 6.0 t, pressing time: 60 seconds) to obtain treated sample toner.

The sample toner prior to treatment is also pelletized into a pellet having a diameter of 3 mm and a thickness of 2 mm to obtain the pelletized sample toner prior to treatment.

Using a fluorescent X-ray instrument (ZSX-100e, manufactured by Rigaku Corporation), the zinc content W (percent by mass) of the treated sample toner and the zinc content W₀ (percent by mass) of the pelletized sample toner prior to treatment are measured.

The content of the fine zinc particles (percent by mass) is then calculated based on Relationship 1 below. The calibration curve used is prepared in advance using sample toners having zinc contents of 0.1 parts, 1 part, and 1.8 parts per 100 parts of toner.

Content of fine zinc particles(percent by mass)=(W₀−W)/W₀×100 Relationship 1)

As the volume-average particle diameter of the zinc stearate particles, 3 to 20 μm is preferable, and 5 to 15 μm is more preferable. When the volume-average particle diameter is at least 3 μm, embedding of the zinc stearate particles into the toner base particles can be suppressed, so that the zinc stearate particles are released from the toner base particles and provide an improved coating effect on the photoconductor, thereby yielding excellent cleaning performance. When the volume-average particle diameter is at most 20 μm, capturing of the zinc stearate particles by the cleaning blade can be suppressed, thereby yielding excellent cleaning performance.

There is no particular limitation on the method of measuring the volume-average particle diameter of the zinc stearate particles, and it may be appropriately selected according to a particular application.

For example, the zinc stearate particles may be observed and photographed using a scanning electron microscope (SEM), and the longest length of randomly selected zinc stearate particles (100 to 200 particles measured) in the SEM images may be measured using the image-analysis software ImageJ, and the average particle diameter may be calculated.

The volume-average particle diameter of the zinc stearate particles contained in the toner can be measured by, for example, the following method.

A small amount of toner subjected to external addition treatment using a Henschel mixer is sampled, and SEM images of the zinc stearate particles contained in the toner are taken using a scanning electron microscope under the imaging conditions described below.

### Imaging Condition

Scanning Electron Microscope: SU-8230 (available from Hitachi High-Technologies Corporation)
Magnification: 35,000×
Imaging Modes: SE (L) (Secondary Electrons), Backscattered Electrons (BSE)
Accelerating Voltage: 2.0 kV
Beam Current: 1.0 μA
Probe Current: Normal
Focus Mode: UHR
Working Distance (WD): 8.0 mm

The longest length of the randomly selected zinc stearate particles (100 to 200 particles measured) is measured from the photographed SEM images using the image-analysis software ImageJ, and the volume-average particle diameter is calculated. In calculating the volume-average particle diameter, five lots of zinc stearate particles are measured, and when at least 80 percent of the measurement results fall within 3 to 20 m, the zinc stearate particles are regarded as satisfying the numerical range of the volume-average particle diameter in this embodiment.

Examples of industrial methods of producing zinc stearate particles include, for example, wet methods and dry methods. There is no particular limitation on the production method; however, zinc stearate particles produced by a wet method and having a scale-like form are preferable.

In the wet method, zinc stearate particles can be obtained by saponifying stearic acid with caustic soda or caustic potash to form an alkaline soap, and then reacting the soap with zinc.

In the above dry method, zinc stearate particles can be obtained by reacting stearic acid with zinc oxides or zinc hydroxides.

Examples of methods of micronizing zinc stearate particles include, for example, a method of dry pulverization of dried zinc stearate particles using high-pressure air, and a method of wet pulverization in which the zinc stearate particles are dispersed in a substance such as silicone oil and pulverized with a beads mill.

Zinc stearate particles can be procured.

One example of procurable products is SZ-2000 (manufactured by Sakai Chemical Industry Co., Ltd.).

### Other External Additive

The toner of the present disclosure may further optionally contain external additives other than the zinc stearate particles.

Specific examples of such other external additives include, but are not limited to, fatty acid metal salts such as calcium stearate and aluminum stearate; fine titanium dioxide (titania) particles; fine alumina particles; and polymer fine particles produced by soap-free emulsion polymerization, such as fine polymethyl methacrylate particles and fine polystyrene particles.

Commercially available fine titania particles can be used. Specific examples include, but are not limited to, P-25 (manufactured by Nippon Aerosil Co., Ltd.); STT-30 and STT-65C-S (manufactured by Titan Kogyo, Ltd.); TAF-140 (manufactured by Fuji Titanium Industry Co., Ltd.); and MT-150W, MT-500B, MT-600B, and MT-150A (manufactured by Tayca Corporation).

Specific examples of the hydrophobized fine titan oxide particles include, but are not limited to, T-805 (available from NIPPON AEROSIL CO., LTD.); STT-30A and STT-65S-S (both available from TITAN KOGYO, LTD.); TAF-500T and TAF-1500T (both available from FUJI TITANIUM INDUSTRY CO., LTD.); MT-100S and MT-100T (both available from TAYCA CORPORATION); and IT-S (available from ISHIHARA SANGYO KAISHA LTD.).

The hydrophobized oxide fine particles, the hydrophobized silica fine particles, the hydrophobized titania fine particles, and the hydrophobized fine alumina particles can be obtained by treating fine hydrophillic particles with a silane coupling agent such as methyl trimethoxysilane, methyltrimethoxy silane, and octyl trimethoxysilane. Silicon oil treated fine oxide particles and fine inorganic particles, which are optionally treated with heated silicone oil, are also preferable.

Specific examples of the silicone oils include, but are not limited to, dimethyl silicone oil, methylphenyl silicone oil, chlorophenyl silicone oil, methylhydrogene silicone oil, alkyl-modified silicone oil, fluorine-modified silicone oil, polyether-modified silicone oil, alcohol-modified silicone oil, amino-modified silicone oil, epoxy-modified silicone oil, epoxy/polyether silicone oil, phenol-modified silicone oil, carboxyl-modified silicone oil, mercapto-modified silicone oil, acryli- or methacryl-modified silicone oil, and α-methylstyrene-modified silicone oil.

Specific examples of such fine inorganic particles include, but are not limited to, silica, alumina, titanium oxide, barium titanate, magnesium titanate, calcium titanate, strontium titanate, iron oxide, coper oxide, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride. Among these, silica and titanium dioxide are preferred.

The proportion of the other external additive is not particularly limited and can be suitably selected according to a particular application. It is preferably from 0.1 to 5 percent by mass and more preferably from 0.3 to 3 percent by mass based on a toner.

### Method of Producing Toner

The method of producing the toner is not particularly limited and may be appropriately selected according to a particular application. For example, it includes, for example, a wet granulation method and pulverization method. Examples of the wet granulation method include, for example, a dissolution-suspension method and an emulsion-aggregation method. Because molecular chain scission due to kneading and the difficulty of uniformly kneading high-molecular-weight resins and low-molecular-weight resins occur during kneading of the binder resin, methods that do not involve kneading of the binder resin, such as the dissolution-suspension method and the emulsion-aggregation method, are preferable.

From the viewpoint of resin uniformity within the toner particles, the dissolution-suspension method is more preferable.

### Dissolution Suspension Method

The dissolution-suspension method includes, for example, methods including a toner material phase preparation, an aqueous medium phase preparation; an emulsification or dispersion preparation; and an organic solvent removal, and it may further optionally include additional processes.

### Toner Material Phase (Oil Phase) Preparation

The toner material phase preparation is not particularly limited as long as toner materials containing at least a binder resin and other optional substances such as a colorant and a release agent are dissolved or dispersed in an organic solvent to prepare a solution or dispersion of the toner materials (also referred to as the toner material phase or the oil phase). The preparation process may be appropriately selected according to a particular application.

There is no particular limitation on the organic solvent, and it may be appropriately selected according to a particular application; however, from the viewpoint of ease of removal, volatile solvents having a boiling point of less than 150 degrees Celsius are preferable.

Specific examples of such organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. Among these, ethyl acetate, toluene, xylene, benzene, methylene chloride, 1,2-dichloroethane, chloroform, and carbon tetrachloride are preferable and ethyl acetate is particularly preferable.

These can be used alone or in combination.

The proportion of the organic solvent has no particular limitation and can be suitably selected according to a particular application. For example, the proportion is preferably at most 300 parts by mass, more preferably at most 100 parts by mass, and furthermore preferably from 25 to 70 parts by weight per 100 parts by mass of toner materials.

### Aqueous Medium Phase (Aqueous Phase) Preparation

As the aqueous medium phase preparation, any process of preparing an aqueous medium phase may be used, and there is no particular limitation; the process may be appropriately selected according to a particular application. In the aqueous medium phase preparation, it is preferable to prepare an aqueous medium phase containing fine resin particles in the aqueous medium.

The aqueous medium is not particularly limited and can be suitably selected according to a particular application. It includes, for example, water, a solvent miscible with water, and a mixture thereof. Among these, water is particularly preferable.

The solvent miscible with water is not particularly limited as long as it can be miscible with water and can be suitably selected according to a particular application. It includes, for example, alcohol, dimethyl formamide, tetrahydrofuran, cellosolves, and lower ketones.

Specific examples of alcohols include, but are not limited to, methanol, isopropanol, and ethylene glycol.

Specific examples of the lower ketones include, but are not limited to, acetone and methyl ethyl ketone.

These can be used alone or in combination.

The aqueous medium phase is prepared by dispersing the fine resin particles in the aqueous medium under the presence of a surfactant. Surfactants, fine resin particles, and others may be appropriately added to the aqueous medium in order to improve the dispersion of the toner materials.

There is no specific limitation on the amount of the surfactant and the fine resin particles to the aqueous medium and it can be suitably selected according to a particular application. For example, it is preferably from 0.5 to 10 percent by mass.

The surfactant has no specific limitation and can be suitably selected according to a particular application. Examples include, but are not limited to, anionic surfactants, cationic surfactants, and amphoteric surfactants.

Examples of anionic surfactants include, but are not limited to, fatty acid salts; alkyl sulfate salts; alkylaryl sulfonate salts; alkyl diaryl ether disulfonate salts; dialkyl sulfosuccinate salts; alkyl phosphate salts; naphthalene sulfonate formalin condensates; polyoxyethylene alkyl phosphate ester salts; and glycerol borate fatty acid esters.

Any resin capable of forming an aqueous dispersion can be used as the fine resin particle and include thermoplastic resins and thermocurable resins.

Specific examples of the materials of the fine resin particles include, but are not limited to, vinyl resins, polyurethane resins, epoxy resins, polyester resins, polyamide resins, polyimide resins, silicone resins, phenolic resins, melamine resins, urea resins, aniline resins, ionomer resins, and polycarbonate resins. These can be used alone or in combination.

Among these resins, vinyl resins, polyurethane resins, epoxy resins, polyester resins, and mixtures thereof are preferably used because an aqueous dispersion body including fine spherical particulates can be easily prepared.

Specific examples of the vinyl-based resins include, but are not limited to, polymers, which are prepared by polymerizing a vinyl monomer or copolymerizing vinyl monomers, such as styrene-(meth)acrylate resins, styrene-butadiene copolymers, (meth)acrylic acid-acrylate copolymers, styrene-acrylonitrile copolymers, styrene-maleic anhydride copolymers, and styrene-(meth)acrylic acid copolymers.

The volume average particle diameter of the fine resin particle is not particularly limited and can be suitably selected according to a particular application. It is preferably from 10 to 60 nm and preferably from 10 to 40 nm.

In preparing the aqueous medium phase, cellulose may be used as a dispersant. Specific examples of the cellulose include, but are not limited to, methyl cellulose, hydroxyethyl cellulose, hydroxypropyl cellulose, and sodium carboxymethyl cellulose.

### Preparation of Emulsion or Dispersion

As the emulsification or dispersion preparation, any process in which the solution or dispersion of the toner materials (the toner material phase) and the aqueous medium phase are mixed and emulsified or dispersed to prepare an emulsion or dispersion may be used, and there is no particular limitation; the process may be appropriately selected according to a particular application.

There is no specific limitation on the emulsification or dispersion method and it can be suitably selected according to a particular application. For example, dispersion can be conducted by using a known dispersion device. Specific examples of the dispersion device include, but are not limited to, a low speed shearing type dispersion device and a high speed shearing type dispersion device.

As the amount of the aqueous medium phase used per 100 parts by mass of the toner material phase, there is no particular limitation, and it may be appropriately selected according to a particular application; however, 50 to 2,000 parts by mass is preferable, and 100 to 1,000 parts by mass is more preferable. When the amount used is 50 to 2,000 parts by mass, the dispersion state of the toner material phase becomes suitable, and toner particles having a predetermined particle diameter can be obtained. In addition, when the amount is at most 2,000 parts by mass, it is economically preferable.

### Process of Removing Organic Solvent

As the organic solvent removal, any process may be used as long as it removes the organic solvent from the emulsion or dispersion to obtain a desolvated slurry. There is no particular limitation, and the process may be appropriately selected according to a particular application.

Examples of methods of removing the organic solvent include (1) gradually raising the temperature of the entire reaction system to completely evaporate and remove the organic solvent contained in the oil droplets of the emulsified or dispersion, and (2) spraying the emulsion or dispersion into a drying atmosphere to completely remove the organic solvent contained in the oil droplets of the emulsion or dispersion. The toner particle is formed when the organic solvent is removed.

### Other Optional Process

Other optional processes include, for example, washing and drying.

### Washing

As the washing process, any process may be used as long as it washes the desolvated slurry with water after the organic solvent removal, and there is no particular limitation; the process may be appropriately selected according to a particular application. One example of the water is deionized water.

In the washing process, it is preferable to add an alkali such as sodium hydroxide to the washing liquid. With alkali washing, the shell portion of the core-shell fine resin particles adhering to the toner core particles is removed, thereby ensuring low-temperature fixability of the toner.

### Drying

As the drying process, any process may be used as long as it dries the toner particles obtained in the washing process, and there is no particular limitation; the process may be appropriately selected according to a particular application.

### Pulverization Method

In the pulverization method, for example, a toner material containing at least a binder resin is melt-kneaded, and thereafter pulverized and classified to produce toner base particles.

The melt-kneading process is performed by mixing the toner material and charging it into a melt-kneading machine. A single-screw or twin-screw continuous mixing and kneading machine or a batch type mixing and kneading machine by a roll mill can be used as the melt-kneading machine.

Specific examples thereof include, but are not limited to, KTK type twin-screw extruders (manufactured by KOBE STEEL, LTD.), TEM type extruders (manufactured by TOSHIBA MACHINE CO., LTD), twin-screw extruders (manufactured by KCK), PCM type twin-screw extruders (manufactured by IKEGAI CORP.), and Ko-kneaders (manufactured by Buss). This melt-kneading are required to be conducted under suitable conditions not to sever the molecular chain of the binder resins. Specifically, the temperature during the melt-kneading is determined according to the softening point of the binder resin. If the temperature is too high relative to the softening point, the molecular chain is likely to be severely severed. When the temperature is too low relative to the softening point, dispersion may not proceed smoothly.

In the pulverization process, the mixture obtained in the melt-kneading is pulverized. During this pulverization, the melt-kneaded matter is preferably subjected to coarse pulverizing, followed by fine pulverizing. The melt-kneaded matter is pulverized by colliding with a collision board in a jet stream, colliding particles in a jet stream, or pulverizing at narrow gaps between a stator and a rotor that mechanically rotates.

In the classifying process, the pulverized matter obtained in the pulverization is classified and adjusted to have a predetermined particle diameter. The classification can be performed by removing fine particle portions using a cyclone, a decanter, or a centrifugal.

### Developing Agent

The developing agent according to an embodiment of the present disclosure contains the toner of one embodiment of the present disclosure. The developing agent can be used as a single-component developing agent or a two-component developing agent mixed with carrier particles. In particular, when used with high-speed printers that correspond to the recent improvement in information processing speed, the two-component developing agent is preferable to extend its working life.

In a case where a one-component developing agent using the toner of an embodiment of the present disclosure is used and replenished, the variation in the particle diameter of the toner is small, no filming of the toner on the developing roller occurs, and no fusion bonding of the toner onto members such as a blade for regulating the thickness of the toner layer occurs. Consequently, good and stable development performance and image quality can be achieved even during long-term use (stirring) of the developing device.

In a case of a two-component developing agent using the toner of an embodiment of the present disclosure, even when the toner is consumed and replenished for an extended period of time, the particle diameter of the toner in the developing agent varies little. In addition, good and stable developability is sustained even when the developing agent is stirred in a development device for an extended period of time.

Furthermore, the developing agent of an embodiment of the present disclosure can also be used as a developing agent for replenishment.

### Carrier

There is no specific limitation on the carrier and it can be suitably selected according to a particular application. It is preferable to use a carrier particle that has a core material and a resin layer covering the core material.

### Core Material

As the core material, any particles having magnetic properties may be used without particular limitation and may be appropriately selected according to a particular application. Ferrite, magnetite, iron, and nickel are preferred. In addition, in the case of ferrite, considering the adaptability to the environment which has been of a high concern recently, it is preferable to use, for example, manganese ferrite, manganese—magnesium ferrite, manganese strontium ferrite, manganese—magnesium—strontium ferrite, and lithium-based ferrite instead of typical copper—zinc ferrite.

### Resin Layer

There is no specific limitation on the selection of the material for the resin layer mentioned above and it can be suitably selected according to a particular application. Specific examples include, but are not limited to, amino-based resins, polyvinyl-based resins, polystyrene-based resins, polycarbonate-based resins, polyethylene resins, polyvinyl fluoride resins, polyvinylidene fluoride resins, polytrifluoroethylene resins, polyhexafluoropropylene resins, copolymers of vinylidene fluoride and acrylate monomer, copolymers of vinylidene fluoride and vinyl fluoride, fluoroterpolymers such as terpolymers of tetrafluoroethylene, fluorovinylidene, and monomer including no fluorine atom, and silicone resins. These can be used alone or in combination.

There is no specific limitation on the silicone resins and it can be suitably selected according to a particular application. Specific examples include, but are not limited to, straight silicone resins formed of only organosiloxane bond; and modified silicone resins modified by alkyd resins, polyester resins, epoxy resins, acrylic resins, and urethane resins.

The silicone resin can be procured.

Specific examples of procurable straight silicone resins include, but are not limited to, KR271, KR255, and KR152, available from Shin-Etsu Chemical Co., Ltd., and SR2400, SR2406, and SR2410, available from DOW CORNING TORAY CO., LTD.

Specific examples of the procurable modified silicone resins include, but are not limited to, KR206 (alkyd-modified silicone resins), KR5208 (acrylic-modified silicone resins), ES1001N (epoxy-modified), and KR305 (urethane-modified silicone resins), all available from Shin-Etsu Chemical Co., Ltd., and SR2115 (epoxy-modified silicone resins) and SR2110 (alkyd-modified silicone resins), both available from DOW CORNING TORAY CO., LTD.

In this case, it is possible to use simple silicone resin, but it is also possible to use other components for cross-linking reactions and charge control components simultaneously.

The content of the component for forming the resin layer in the carrier is preferably 0.01 to 5.0 percent by mass. When the content is within 0.01 to 5.0 percent by mass, the following problems can be prevented:
a failure in which a uniform resin layer cannot be formed on the surface of the core material; and
a failure in which the resin layer becomes excessively thick, causing granulation between carriers and resulting in non-uniform carrier particles.

When the developing agent is a two-component developing agent, the toner content is not particularly limited and may be appropriately selected according to a particular application; 2.0 to 12.0 parts by mass per 100 parts by mass of the carrier is preferred, and 2.5 to 10.0 parts by mass is more preferred.

### Toner Accommodating Unit

The toner accommodating unit in the present embodiment contains toner in a unit capable of accommodating the toner.

Some examples of the toner accommodating unit include a toner accommodating container, a developing unit, and a process cartridge.

The toner accommodating container is a vessel containing a toner.

The developing unit refers to a device that accommodates toner and develops with the toner.

### Process Cartridge

The process cartridge relating to an embodiment of the present disclosure is made to be detachably attachable to an image forming apparatus. It includes at least an electrostatic latent image bearer (photoconductor) that bears an electrostatic latent image and a developing device that renders the electrostatic latent image on the electrostatic latent image bearer visible with a developing agent containing the toner of an embodiment of the present disclosure to form a toner image.

The process cartridge of an embodiment of the present disclosure may furthermore optionally include other optional devices.

The developing device includes at least a developing agent container that contains the developing agent of the present disclosure and a developing agent bearer that bears and conveys the developing agent in the developing agent container. The developing device may furthermore optionally include a regulating member for regulating the thickness of the developing agent borne on the bearer.

### Image Forming Apparatus and Image Forming Method

The image forming apparatus of an embodiment of the present disclosure includes an electrostatic latent image bearer, an electrostatic latent image forming device, a development device, and other optional devices.

The image forming method of an embodiment of the present disclosure includes forming an electrostatic latent image, developing the electrostatic latent image, and other optional processes.

Electrostatic latent Image Bearer

There is no specific limitation on the electrostatic latent image bearer with regard to the material, shape, structure, and size thereof, and it can be suitably selected from any known image bearers according to a particular application. The image bearer suitably employs a drum-like or belt-like shape. Also, an inorganic image bearer made of amorphous silicon or selenium, or an organic image bearer made of polysilane, or phthalopolymethine is suitably used.

One example of the organic photoconductor is a layered photoconductor, including layers, i.e., a charge-generation layer formed of a non-metallic material like phthalocyanine, or titanyl phthalocyanine dispersed in a binder resin and a charge-transport layer formed of a charge transport material dispersed in a binder resin, stacked on a substrate such as an aluminum drum.

Another type is a single-layer photoconductor with a single-layer structure on a substrate, featuring a photosensitive layer formed of both a charge-generation material and a charge-transport material dispersed in a binder resin. In the single-layer photoconductor, hole transport agents and electron transport agents can be added to the photosensitive layer as charge transport materials.

Additionally, an undercoat layer may be provided between the substrate and either the charge generation layer of a multi-layer photoconductor or the photosensitive layer of a single-layer photoconductor.

### Electrostatic Latent Image Forming Device and Electrostatic Latent Process

The electrostatic latent image forming device has no particular limitation as long as it can form an electrostatic latent image on an electrostatic latent image bearer and can be suitably selected according to a particular application. For example, a device including a charging member for charging the surface of an electrostatic latent image bearer and an irradiating device for irradiating the surface of the electrostatic latent image bearer imagewise is suitable.

The electrostatic latent image forming process has no particular limit as long as it can form an electrostatic latent image on the electrostatic latent image bearer and can be suitably selected according to a particular application. For example, the process is conducted by charging the surface of an electrostatic latent image bearer and irradiating the surface imagewise with the electrostatic latent image forming device.

### Charging Device and Charging

The charging device (charging member, charger) is not particularly limited and can be suitably selected to according to a particular application. Specific examples include, but are not limited to, a known contact type charger that includes an electroconductive or semiconductive roller, brush, film, or a rubber blade, and a non-contact type charger using corona discharging such as corotron and scorotron.

Charging is accomplished, for instance, by applying a bias to the surface of the image bearer using the charging device.

The charging device may employ a roller form and any other form such as a magnetic brush and a fur brush, and can be selected according to the specification or form of an image forming apparatus.

The charging device not limited to the contact type charging device but is preferably used because such a charging member contributes to manufacturing an image forming apparatus producing less amount of ozone.

### Irradiating Device and Irradiation

As the irradiating (exposure) device, any device or member may be used without particular limitation as long as it can perform irradiation (exposure) on the surface of the electrostatic latent-image bearing member that has been charged by the charging member in accordance with the image to be formed, and may be appropriately selected according to a particular application. Examples include various types of irradiating device such as a copying optical system, a rod-lens array system, a laser optical system, and a liquid-crystal shutter optical system.

There is no specific limitation on the structure of the supporting member. It can be selected according to a particular application. Specifically, fluorescent lamps, tungsten lamps, halogen lamps, mercury lamps, sodium lamps, light-emitting diodes (LEDs), semiconductor lasers (LDs), electroluminescence (EL), and others can be employed.

Variety of optical filters can be used to irradiate an electrostatic latent image bearer with beams of light having only a desired wavelength.

It includes, but is not limited to, a sharp cut filter, a band-pass filter, a near infrared filter, a dichroic filter, a coherent filter, and a color conversion filter.

The irradiation is conducted by, for example, irradiating the surface of the electrostatic latent image bearer with the irradiator.

In the present embodiment, a dorsal irradiation system can be employed, where the electrostatic latent image bearer is irradiated from the rear side in an imagewise manner.

### Developing Device and Developing Process

The developing device is not particularly limited and can be suitably selected according to a particular application as long as it can contain a toner for developing an electrostatic latent image formed on an electrostatic latent image bearer to form a toner image as a visible image.

The developing process has no particular limitation as long as the process develops an electrostatic latent image formed on the electrostatic latent image bearer with toner to render the image visible and can be suitably selected according to a particular application. For example, the developing process can be conducted by a developing device.

Preferably, the developing device includes a stirrer for triboelectrically charging toner, a magnetic field generator fixed inside, and a rotatable developing agent bearer that bears a developing agent containing the toner on its surface.

### Other Optional Device and Other Optional Process

Examples of the aforementioned other devices include, but are not limited to, transfer device, a fixing device, a cleaning device, a discharging (quenching) device, a recycling device, and a controlling device.

The other processes include, for example, a transfer process, a fixing process, a cleaning process, a discharging process, a recycling process, and a controlling process.

### Transfer Device and Transfer Process

The transfer device has no particular limitation as long as it can transfer the toner image to a recording medium and can be suitably selected according to a particular application. For example, a transfer device is preferable which includes a primary transfer device to transfer visible images onto an intermediate transfer body to form a complex transfer image and a secondary transfer device to transfer the complex transfer image to a recording medium.

The transfer process has no particular limitation as long as it can transfer a visible image onto a recording medium and can be suitably selected according to a particular application.

It is preferable to employ a configuration in which a visible image is primarily transferred to an intermediate transfer body and thereafter secondarily transferred to a recording medium.

The transfer process can be performed by, for example, charging the electrostatic latent image bearer (photoconductor) with a transfer charging device and by the transfer device.

If an image secondarily transferred to a recording medium is a color image formed of multiple color toners, it is possible to have a configuration in which each color toner image is sequentially overlapped on the intermediate transfer body by the transfer device to form an image thereon, which is secondarily transferred once to a recording medium by an intermediate transfer device.

The intermediate transfer body is not particularly limited and can be suitably selected from the known transfer members including a transfer belt.

The transfer device (the primary transfer device, the secondary transfer device) preferably has a transfer unit for peeling-charging the visible image formed on the image bearer to the side of the recording medium. Specific examples of the transfer unit include, but are not limited to, a corona transfer unit using corona discharging, a transfer belt, a transfer belt, a transfer roller, a pressure transfer roller and an adhesive transfer unit.

A typical example of the recording medium is plain paper but any paper to which a non-fixed image after development is transferred can be suitably used. PET base for an overhead projector can be also used.

### Fixing Device and Fixing

The fixing device has no particular limitation provided that it can fix a visible image transferred onto a recording medium and can be suitably selected according to a particular application. For example, known heating and pressing devices are preferable. As the heating and pressure member, for example, a combination of a heating roller and a pressure roller and a combination of a heating roller, a pressure roller, and an endless belt can be used.

The fixing device has no particular limitation provided that it can fix a visible image transferred onto a recording medium and can be suitably selected according to a particular application. Fixing can be conducted every time each color toner image is transferred to a printing medium. Alternatively, fixing can be conducted for a multi-color superimposed toner image.

The fixing process can be conducted by the fixing device.

The heating temperature at the heating and pressing device is preferably from 80 to 200 degrees Celsius.

In the present embodiment, for example, any known optical fixing device can be used in combination with or in place of the fixing device according to a particular application.

There is no specific limitation on the surface pressure in the fixing process and it can be suitably selected according to a particular application. Preferably, the surface pressure is from 10 to 80 N/cm².

### Cleaning Device and Cleaning Process

As the cleaning device, any device may be used without particular limitation as long as it can remove the toner remaining on the photoconductor, and may be appropriately selected according to a particular application. Specific examples of the cleaning device include, but are not limited to, a magnetic brush cleaner, an electrostatic brush cleaner, a magnetic roller cleaner, a blade cleaner, a brush cleaner, and a web cleaner.

Any cleaning process that can remove the toner remaining on the image bearer is suitably used without limitation according to a particular application. For example, the cleaning process can be conducted by the cleaning device mentioned above.

### Quenching Device and Quenching Process

The quenching (discharging) device has no particular limitation as long as it can apply a discharging bias to a photoconductor for discharging and can be suitably selected according to a particular application. For example, a discharging lamp is suitable.

The discharging process has no specific limitation as long as it includes applying a discharging bias to a photoconductor for discharging and can be suitably selected according to a particular application. For example, the charging process can be conducted by the charging device.

### Recycling Device and Recycling Process

The recycling device has no particular limitation as long as it recycles toner removed by the cleaning device to the development device and can be suitably selected according to a particular application. For example, known conveying devices are suitable.

The recycling process has no particular limitation as long as it includes recycling toner removed in the cleaning process to the developing device and can be suitably selected according to a particular application. For example, the recycling process can be conducted by the recycling device.

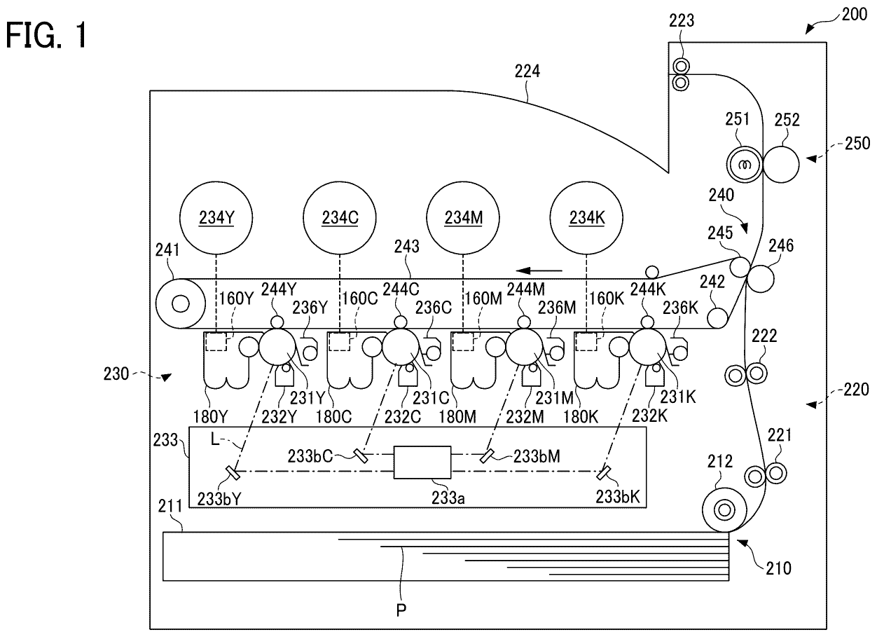

Next, an aspect of image forming with the image forming apparatus of an embodiment of the present disclosure is described with reference to FIG. 1. One of the image forming apparatuses in the present embodiment is a printer. However, the image forming apparatus is not particularly limited to an apparatus such as a printer, a photocopier, a facsimile machine, or a multifunction peripheral as long as it can form images with toner.

An image forming apparatus 200 includes a sheet feeding unit 210, a conveyance unit 220, an image forming part (electrostatic latent image forming device) 230, a transfer unit (transfer device) 240, and a fixing unit (fixing device) 250.

The sheet feeding unit 210 includes a sheet feeding cassette 211 on which sheets to be fed are piled and a feeding roller 212 that feeds a sheet (recording medium) P piled on the sheet feeding cassette 211 one by one.

The conveyance unit 220 includes a roller 221 for conveying the sheet P fed by the feeding roller 212 toward the transfer device 240, a pair of timing rollers 222 for pinching the front end of the sheet P conveyed by the roller 221 on standby and sending out the sheet P to the transfer device 240 at a particular timing, and ejection rollers 223 for ejecting the sheet P on which a color toner image is fixed by the fixing device 250 to an ejection tray 224.

The image forming part 230 includes an image forming unit (electrostatic latent image bearer) 234Y that forms an image using a developing agent containing yellow toner, an image forming unit 234C that forms an image using a developing agent containing cyan toner, an image forming unit 234M that forms an image using a developing agent containing magenta toner, and an image forming unit 234K that forms an image using a developing agent containing black toner, sequentially standing from left to right in the drawing with a particular interval. The image forming part 230 also includes a charger 232 (232Y, 232M. 232C. 232K) and an irradiator 233 that emits beams of light L. The irradiator 233 includes a light source 233a and a polygon mirror 233b (233bY, 233bM, 233bC, 233bK) that redirects the beams of light L to the charger 232.

An arbitrary image forming unit of the image forming units 234Y, 234C, 234M, and 234K is called an image forming unit.

In addition, the developing agent contains toner and carrier. The four image forming units have substantially the same structure except for the individual developing agents used for respective image forming units.

The transfer unit 240 includes a driving roller 241, a driven roller 242, an intermediate transfer belt 243 disposed rotatable counterclockwise in the drawing in accordance with the drive of the driving roller 241, a primary transfer roller (244Y, 244C, 244M, and 244K) disposed facing the drum photoconductor (electrostatic latent image bearer) 231 with the intermediate transfer belt 243 therebetween, and a secondary facing roller 245 and a secondary transfer roller 246 disposed facing each other at the point of the toner image transferred to the sheet P with the intermediate transfer belt 243 therebetween.

A fixing device 250 with a heater inside includes a fixing belt 251 for heating the sheet P and a pressing roller 252 for forming a nip with the fixing belt 251 by rotatably pressing it. Heat is applied with pressure to the color toner image on the sheet P at the nipping portion, thereby fixing the color toner image. The sheet P on which the color toner image is fixed is ejected to the ejection tray 224 by the ejection rollers 223, which completes a series of image forming process.

### Process Cartridge

The process cartridge relating to the present disclosure is made to be detachably attachable to an image forming apparatus. It includes at least an electrostatic latent image bearer and a developing device that renders the electrostatic latent image visible with a developing agent containing the toner of the present disclosure to form a toner image. The process cartridge relating to the present disclosure may furthermore optionally include other optional devices.

The developing device includes at least a developing agent container that contains a developing agent and a developing agent bearer that bears and conveys the developing agent in the developing agent container. The developing device may furthermore optionally include a regulating member for regulating the thickness of the developing agent borne on the bearer.

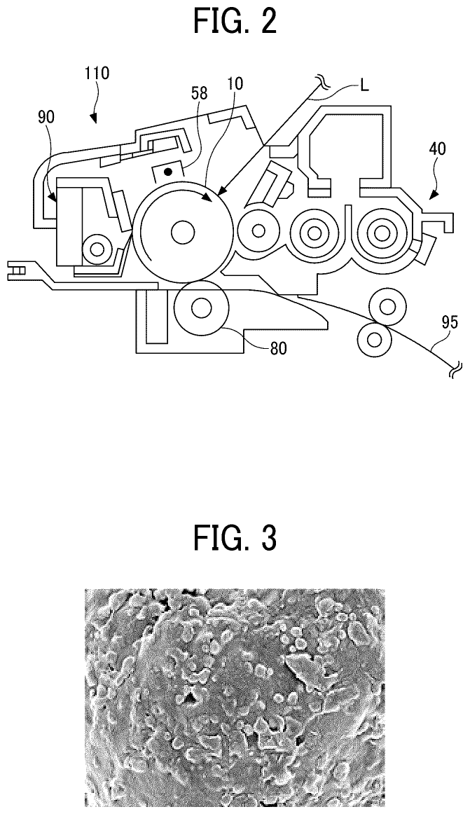

FIG. 2 is a diagram illustrating an example of the process cartridge relating to the present disclosure. The process cartridge 110 includes a drum photoconductor (electrostatic latent image bearer) 10, a corona charger 58, a developing device 40, a transfer roller 80, and a cleaning device (cleaner) 90.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight rations in parts, unless otherwise specified.

### EXAMPLES

Next, the present disclosure is described in detail with reference to Examples but is not limited thereto. The terms “part” and “percent” respectively refer to part by mass and percent by mass.

### Manufacturing Example 1

### Manufacturing of Aqueous Liquid Dispersion (W1-1) of Fine Resin Particle (A1-1)

In a reaction vessel equipped with a stirrer, a heating-cooling device, and a thermometer, 3760 parts of water and 150 parts of polyoxyethylene-1-(allyloxymethyl) alkyl ether sulfate ammonium (Aquaron KH-1025, available from DKS Co., Ltd.) were charged and stirred at 200 rotations per minute for homogenization. The homogenized mixture was heated until the internal temperature reached 75 degrees Celsius. Subsequently, 90 parts of a 10 percent ammonium persulfate solution were added, and then a liquid mixture of 430 parts of styrene, 270 parts of butyl acrylate, and 300 parts of methacrylic acid was dropwise added over 4 hours. After the dropwise addition, the resulting mixture was aged at 75 degrees Celsius for 4 hours, yielding an aqueous liquid dispersion (W1-1) containing fine resin particles (A1-1) of resin (a1-1) as a copolymer of the monomers and polyoxyethylene-1-(allyloxymethyl) alkyl ether sulfate ammonium. The volume-average particle diameter of the fine particles in the aqueous liquid dispersion (W1-1) was 25 nm.

Part of the aqueous liquid dispersion (W1-1) was dried to isolate resin (a1-1). The glass transition temperature Tg of the isolated resin was 53 degrees Celsius and the acid value thereof was 195 mgKOH/g.

### Manufacturing Example 2

### Manufacturing of Aqueous Liquid Dispersion (W1-2) of Fine Resin Particle (A1-2)

In a reaction vessel equipped with a stirrer, a heating-cooling device, and a thermometer, 3710 parts of water and 200 parts of polyoxyethylene-1-(allyloxymethyl) alkyl ether sulfate ammonium (Aquaron KH-1025, available from DKS Co., Ltd.) were charged and stirred at 200 rotations per minute for homogenization. The homogenized mixture was heated until the internal temperature reached 75 degrees Celsius. Subsequently, 90 parts of a 10 percent ammonium persulfate solution were added, and then a liquid mixture of 450 parts of styrene, 250 parts of butyl acrylate, and 300 parts of methacrylic acid was dropwise added over 4 hours. After the dropwise addition, the resulting mixture was aged at 75 degrees Celsius for 4 hours, yielding an aqueous liquid dispersion (W1-2) containing fine resin particles (A1-2) of resin (a1-2) as a copolymer of the monomers and polyoxyethylene-1-(allyloxymethyl) alkyl ether sulfate ammonium. The volume-average particle diameter of the fine particles in the aqueous liquid dispersion (W1-2) was 15 nm.

Part of the aqueous liquid dispersion (W1-2) was dried to isolate resin (a1-2).

The glass transition temperature Tg of the isolated resin was 53 degrees Celsius and the acid value thereof was 195 mgKOH/g.

### Manufacturing Example 3

### Manufacturing of Aqueous Liquid Dispersion (W1-3) of Fine Resin Particle (A1-3)

In a reaction vessel equipped with a stirrer, a heating-cooling device, and a thermometer, 3810 parts of water and 100 parts of polyoxyethylene-1-(allyloxymethyl) alkyl ether sulfate ammonium (Aquaron KH-1025, available from DKS Co., Ltd.) were charged and stirred at 200 rotations per minute for homogenization. The homogenized mixture was heated until the internal temperature reached 75 degrees Celsius. Subsequently, 90 parts of a 10 percent ammonium persulfate solution were added, and then a liquid mixture of 400 parts of styrene, 300 parts of butyl acrylate, and 300 parts of methacrylic acid was dropwise added over 4 hours. After the dropwise addition, the resulting mixture was aged at 75 degrees Celsius for 4 hours, yielding an aqueous liquid dispersion (W1-3) containing fine resin particles (A1-3) of resin (a1-3) as a copolymer of the monomers and polyoxyethylene-1-(allyloxymethyl) alkyl ether sulfate ammonium. The volume-average particle diameter of the fine particles in the aqueous liquid dispersion (W1-3) was 52 nm.

Part of the aqueous liquid dispersion (W1-3) was dried to isolate resin (a1-3). The glass transition temperature Tg of the isolated resin was 53 degrees Celsius and the acid value thereof was 195 mgKOH/g.

### Manufacturing Example 4

### Manufacturing of Aqueous Liquid Dispersion (W2-1) of Fine Resin Particle (A2-1)

In a reaction vessel equipped with a stirrer, a heating-cooling device, and a thermometer, 667 parts of the aqueous liquid dispersion (W1-1) and 248 parts of water were charged. To this mixture, 0.267 parts of tert-butyl hydroperoxide (Parbutyl H, available from NOF CORPORATION) were added, followed by heating until the internal temperature reached 70 degrees Celsius. Subsequently, a mixture of 43.3 parts of styrene, 23.3 parts of butyl acrylate, and 18.0 parts of a 1 percent ascorbic acid solution was dropwise added over 2 hours. After the dropwise addition, the resulting mixture was aged at 70 degrees Celsius for four hours, yielding a dispersion (W2-1) of fine resin particles (A2-1) having a core-shell structure, in which the fine resin particles in the aqueous dispersion (W1-1) served as seeds, resin (a2-1) formed the core as a polymer obtained by copolymerizing the monomers, and the resin (a1-1) formed the shell. The volume average particle diameter of the fine resin particle (A2-1) was 27 nm.

In addition, the aqueous liquid dispersion (W2-1) was neutralized with a 10 percent aqueous ammonia solution until the pH reached 9.0, and the neutralized dispersion was centrifuged. The resulting precipitate was then solidified to isolate the resin (a2-1). The resin had a Tg of 53 degrees Celsius.

### Manufacturing Example 5

### Manufacturing of Aqueous Liquid Dispersion (W2-2) of Fine Resin Particle (A2-2)

In a reaction vessel equipped with a stirrer, a heating-cooling device, and a thermometer, 667 parts of the aqueous liquid dispersion (W1-2) and 248 parts of water were charged. To this mixture, 0.267 parts of tert-butyl hydroperoxide (Parbutyl H, available from NOF CORPORATION) were added, followed by heating until the internal temperature reached 70 degrees Celsius. Subsequently, a mixture of 43.3 parts of styrene, 23.3 parts of butyl acrylate, and 18.0 parts of a 1 percent ascorbic acid solution was dropwise added over 2 hours. After the dropwise addition, the resulting mixture was aged at 70 degrees Celsius for four hours, yielding a dispersion (W2-2) of fine resin particles (A2-2) having a core-shell structure, in which the fine resin particles in the aqueous dispersion (W1-2) served as seeds, resin (a2-2) formed the core as a polymer obtained by copolymerizing the monomers, and the resin (a1-2) formed the shell. The volume average particle diameter of the fine resin particle (A2-2) was 17 nm.

In addition, the aqueous liquid dispersion (W2-2) was neutralized with a 10 percent aqueous ammonia solution until the pH reached 9.0, and the neutralized dispersion was centrifuged. The resulting precipitate was then solidified to isolate the resin (a2-2). The resin had a Tg of 53 degrees Celsius.

### Manufacturing Example 6

### Manufacturing of Aqueous Liquid Dispersion (W2-3) of Fine Resin Particle (A2-3)

In a reaction vessel equipped with a stirrer, a heating-cooling device, and a thermometer, 667 parts of the aqueous liquid dispersion (W1-3) and 248 parts of water were charged. To this mixture, 0.267 parts of tert-butyl hydroperoxide (Parbutyl H, available from NOF CORPORATION) were added, followed by heating until the internal temperature reached 70 degrees Celsius. Subsequently, a mixture of 43.3 parts of styrene, 23.3 parts of butyl acrylate, and 18.0 parts of a 1 percent ascorbic acid solution was dropwise added over 2 hours. After the dropwise addition, the resulting mixture was aged at 70 degrees Celsius for four hours, yielding a dispersion (W2-3) of fine resin particles (A2-3) with a core-shell structure, in which the fine resin particles in the aqueous dispersion (W1-3) served as seeds, resin (a2-3) formed the core as a polymer obtained by copolymerizing the monomers, and the resin (a1-3) formed the shell. The volume average particle diameter of the fine resin particle (A2-3) was 54 nm.

In addition, the aqueous liquid dispersion (W2-3) was neutralized with a 10 percent aqueous ammonia solution until the pH reached 9.0, and the neutralized dispersion was centrifuged. The resulting precipitate was then solidified to isolate the resin (a2-3). The resin had a Tg of 53 degrees Celsius.

The materials for the liquid dispersions manufactured in Manufacturing Examples 1 to 6 are shown in Table 1.

TABLE 1
Manufacturing Example 7

Fine resin particle A

| Aqueous liquid | Fine resin | |
|---|---|---|
| dispersion | particle | Resin material |
| W1-1 (Manufacturing | A1-1 | a1-1 |
| Example 1) | | |
| W1-2 (Manufacturing | A1-2 | a1-2 |
| Example 2) | | |
| W1-3 (Manufacturing | A1-3 | a1-3 |
| Example 3) | | |
| W2-1 (Manufacturing | A2-1 | W1-1 as core material |
| Example 4) | | core: a2-1 |
| | | shell: a1-1 |
| W2-2 (Manufacturing | A2-2 | W1-2 as core material |
| Example 5) | | core: a2-2 |
| | | shell: a1-2 |
| W2-3 (Manufacturing | A2-3 | W1-3 as core material |
| Example 6) | | core: a2-3 |
| | | shell: a1-3 |

### Synthesis of Amorphous Polyester Resin b-1

A reaction vessel equipped with a condenser, a stirrer, a heating-cooling device, a thermometer, and a nitrogen inlet tube was charged with 425 parts of an adduct of bisphenol A with 2 moles of PO, 100 parts of propylene glycol, 634 parts of an adduct of terephthalic acid with 2 moles of propylene glycol, and 0.5 part of titanium diisopropoxide bis(triethanolaminate) as a condensation catalyst, and the mixture was reacted at 230 degrees Celsius for 12 hours. The reaction was then continued under reduced pressure of 10 to 15 mmHg. The amount of propylene glycol recovered was 195 parts by mass. After subsequently cooling the reaction mixture to 180 degrees Celsius, 30 parts of trimellitic anhydride was added, and the mixture was reacted at 180 degrees Celsius for one hour and then retrieved. The retrieved resin was cooled to room temperature to obtain an amorphous polyester b-1. The resulting resin had a Tg of 42 degrees Celsius, an Mn of 2400, an Mw of 5400, a hydroxyl value of 32 mgKOH/g, and an acid value of 18 mgKOH/g.

### Manufacturing Example 8

### Preparation of Crystalline Polyester Liquid Dispersion (c-1)

Sebacic acid and 1,6-hexane diol were placed in a 5 L four-necked flask equipped with a nitrogen introducing tube, a dehydration tube, a stirrer, and a thermocouple to achieve a molar ratio of hydroxyl group to carboxyl group, OH/COOH at 0.9:1. Then the mixture was allowed to react together with titanium tetraisopropoxide (500 ppm to the resin portion) at 180 degrees Celsius for ten hours, followed by a 3-hour reaction at temperature raised to 200 degrees Celsius and a 2-hour reaction under a pressure of 8.3 kPa to obtain Crystalline Polyester Resin 1.

A total of 60 parts of the crystalline polyester resin 1 and 400 parts of ethyl acetate were placed in a container equipped with a stirrer and a thermometer and heated to 80 degrees Celsius under stirring. After maintaining the temperature of 80 degrees Celsius for five hours, the system was cooled down to 30 degrees Celsius in an hour. The resulting mixture was subjected to dispersion by a bead mill (ULTRAVISCOMILL, manufactured by AIMEX) under conditions of a liquid transfer speed of 1 kg/hour, a disk peripheral speed of 6 m/s, and a filling ratio of 0.5 mm zirconia beads of 80 percent by volume with three passes to obtain a liquid dispersion (c-1) of crystalline polyester resin.

### Manufacturing Example 9

### Preparation of Colorant Master Batch

A total of 1,200 parts of water, 500 parts of carbon black (Printex 35, available from Degussa AG, DBP oil absorption amount: 42 ml/100 mg, PH: 9.5), and 500 parts of amorphous polyester resin (b-1) were mixed with a Henschel Mixer (available from NIPPON COKE & ENGINEERING. CO., LTD.). The mixture was then kneaded at 150 degrees Celsius for 30 minutes using two rolls and thereafter rolled and cooled down followed by pulverization with a pulverizer to obtain Master Batch 1.

### Manufacturing Example 10

### Manufacturing of Modified Wax

A pressure-resistant reaction vessel equipped with a stirrer, a heating/cooling device, a thermometer, and a dropping bomb was charged with 454 parts of xylene and 150 parts of low-molecular-weight polyethylene (Sanwax LEL-400, manufactured by SANYO CHEMICAL INDUSTRIES). After nitrogen substitution, the mixture was heated to 170 degrees Celsius under stirring, and a mixed solution of 595 parts of styrene, 255 parts of methyl methacrylate, 34 parts of di-t-butyl peroxyhexahydroterephthalate, and 119 parts of xylene was added dropwise over three hours at the same temperature, followed by maintaining the mixture at the same temperature for an additional 30 minutes. Subsequently, xylene was removed under a reduced pressure of 0.039 MPa to obtain a modified wax. The graft-chain SP value of the modified wax was 10.35 (cal/cm³)^{1/2}, its Mn was 1900, its Mw was 5200, and its Tg was 57 degrees Celsius.

### Manufacturing Example 11

### Preparation of Wax Dispersion 1

In a reaction vessel equipped with a condenser, a stirrer, a heating-cooling device, and a thermometer, 10 parts of paraffin wax (HNP-9, manufactured by NIPPON SEIRO CO., LTD.), 1 part of the modified wax, and 33 parts of ethyl acetate were charged. The mixture was heated to 78 degrees Celsius and stirred at the same temperature for 30 minutes, and then cooled to 30 degrees Celsius over one hour to crystallize the paraffin wax into fine particles. The resulting mixture was further subjected to wet pulverization using an Ultravisco Mill (manufactured by AIMEX CO., Ltd. To obtain wax dispersion 1. The wax dispersion 1 had a volume average particle diameter of 0.25 μm.

### Manufacturing Example 12

### Manufacturing of Reactive Prepolymer

In a reaction vessel equipped with a condenser, a stirrer, and a nitrogen inlet tube, 3-methyl-1,5-pentanediol, isophthalic acid, adipic acid, and trimellitic anhydride were charged together with titanium tetraisopropoxide (1,000 ppm relative to the resin components) such that the molar ratio of hydroxyl groups to carboxyl groups (OH/COOH) was 1.5, the diol component consisted of 100 percent by mol of 3-methyl-1,5-pentanediol, the dicarboxylic acid component consisted of 40 percent by mol of isophthalic acid and 60 percent by mol of adipic acid, and the amount of trimellitic anhydride was 1 percent by mol of the total monomers.

Subsequently, the temperature was raised to 200 degrees C. over approximately 4 hours and then to 230 degrees C. over 2 hours, which allowed reaction to proceed until the effluent water ceased.

Thereafter, the resulting reaction product was allowed to react for five hours under reduced pressure of from 10 to 15 mmHg to obtain intermediate polyester C-1.

Next, the intermediate polyester A-1 and isophorone diisocyanate (IPDI) were introduced into a reaction vessel equipped with a cooling tube, a stirrer, and a nitrogen introduction pipe at a molar ratio (isocyanate groups of IPDI/hydroxyl groups of Intermediate Polyester) of 2.0. After dilution with ethyl acetate to form a 50 percent ethyl acetate solution, the resulting mixture was allowed to react at 100 degrees Celsius for 5 hours, thereby obtaining Reactive Prepolymer.

### Manufacturing Example 13

### Synthesis of Amorphous Hybrid Resin d-1

In a 5-L four-necked flask equipped with a nitrogen inlet tube, a dehydration tube, a stirrer, and a thermocouple, 7.2 g of 2,3-butanediol, 6.08 g of 1,2-propanediol, 18.59 g of terephthalic acid, and 0.18 g of tin(II) 2-ethylhexanoate were charged. Nitrogen gas was introduced into the vessel to maintain an inert atmosphere, and the mixture was heated. After maintaining the temperature at 180 degrees Celsius for one hour, the temperature was increased from 180 to 230 degrees Celsius at a rate of 10 degrees Celsius/hr, and the mixture was then subjected to a polycondensation reaction at 230 degrees Celsius for ten hours, followed by an additional reaction at 230 degrees Celsius under 8.0 kPa for one hour. After cooling to 160 degrees Celsius, 0.6 g of acrylic acid, 7.79 g of styrene, 1.48 g of 2-ethylhexyl acrylate, and dibutyl peroxide were added dropwise over one hour using a dropping funnel. After the completion of the dropwise addition, the mixture was kept at 160 degrees Celsius and allowed to undergo an addition-polymerization aging reaction for one hour. The temperature was then increased to 210 degrees Celsius, 4.61 g of trimellitic anhydride was added, and the mixture was reacted at 210 degrees Celsius for two hours. Thereafter, the reaction was continued at 210 degrees Celsius under 10 kPa until the desired softening point was reached, thereby obtaining amorphous hybrid resin (d-1).

The SP value of amorphous hybrid resin (d-1) was 10.8 (cal/cm³)^{1/2}.

Amorphous hybrid resin (d-1) had a weight-average molecular weight of 55,000, a number-average molecular weight of 2,800, a Tg of 55 degrees Celsius, and an acid value of 9.4 mgKOH/g.

### Preparation of Carrier

A total of 100 parts of silicone resin (organo straight silicone), 5 parts of 7-(2-aminoethyl)aminopropyl trimethoxy silane, and 10 parts of carbon black were added to 100 parts of toluene followed by dispersion for 20 minutes by a HOMOMIXER to prepare a resin layer liquid application. Using a fluid bed type coating device, the resin layer liquid application was applied to the surface of spherical magnetite with an average particle diameter of 50 m, totaling 1,000 parts by mass, to produce Carrier.

### Example 1

### Manufacturing of Toner 1

### Preparation of Oil Phase

Into a vessel, 21 parts of wax dispersion 1, 47 parts of crystalline polyester dispersion (c-1), 49 parts of amorphous polyester (b-1), 5 parts of amorphous hybrid resin (d-1), 17 parts of Master Batch 1, and 30 parts of ethyl acetate were charged and mixed at 5,000 rpm for 60 minutes using a TK Homomixer (manufactured by PRIMIX Corporation. Thus, oil phase 1 was obtained.

### Preparation of Aqueous Phase

A total of 256 parts of water, 5 parts of aqueous liquid dispersion (W2-1), 10 parts of aqueous liquid dispersion (W1-1)], 26 parts of a 48.5-percent aqueous solution of sodium dodecylbiphenyl ether disulfonate (Eleminol MON-7, manufactured by SANYO CHEMICAL INDUSTRIES), and 24 parts of ethyl acetate were mixed and stirred to obtain a milky white liquid. This liquid was determined as aqueous phase 1.

### Emulsification and Removal of Solvent

To the vessel containing Oil Phase 1, 14 parts of the reactive prepolymer and 0.2 parts of isophoronediamine as a curing agent were added, and the mixture was stirred to obtain a liquid mixture. To the resulting liquid mixture, Aqueous Phase 1 was added, and the mixture was stirred using a TK Homomixer at 13,000 rpm for 20 minutes to obtain Emulsion Slurry 1. Next, Emulsion Slurry 1 was transferred into a vessel equipped with a stirrer and a thermometer, and the solvent was removed at 30 degrees Celsius for eight hours. The mixture was then aged at 45 degrees Celsius for four hours to obtain slurry dispersion 1.

### Washing and Drying

After 100 parts of the slurry dispersion 1 was filtered under a reduced pressure, the following operations of 1 to 4 were conducted.
(1): A total of 100 parts of deionized water was added to the filtered cake, mixed using a TK Homomixer at 12,000 rpm for 10 minutes, and subsequently filtered.
(2): Sodium hydroxide at 10 percent was admixed with the filtered cake obtained in the (1) until the pH reached 11, using a TK Homomixer at 12,000 rpm for 30 minutes, and then filtered under reduced pressure.
(3): Hydrochloric acid at 10 percent was admixed with the filtered cake obtained in the (2) until the pH reached 4 to 5, using a TK Homomixer at 12,000 rpm for 10 minutes, and subsequently filtered.
(4): A total of 300 parts of deionized water was added to the filtered cake obtained in (3) and the resulting mixture was mixed by a TK HOMOMIXER at a rate of rotation of 12,000 rpm for 10 minutes followed by filtering. The processes of (1) to (4) were carried out twice to obtain a filtered cake.

The obtained filtered cake was dried with a circulation dryer at 45 degrees Celsius for 48 hours. The dried cake obtained was sieved with a screen with an opening of 75 μm to obtain toner base particle 1.

### External Additive Treatment

To 100 parts of toner base particle 1, 1.5 parts by mass of hydrophobic silica particles (volume-average particle diameter: 50 nm), 1.0 part of hydrophobic titanium oxide (volume-average particle diameter: 20 nm), and 0.12 parts by mass of zinc stearate particles (volume-average particle diameter: 10 μm) were added and mixed using a Henschel mixer to obtain Toner 1.

### Example 2

### Manufacturing of Toner 2

Toner 2 was obtained in the same manner as in Example 1 except that the amount of the zinc stearate particles with a volume average particle diameter of 10 μm was changed from 0.12 to 0.32 parts by mass.

### Example 3

### Manufacturing of Toner 3

Toner 3 was obtained in the same manner as in Example 1 except that the amount of the zinc stearate particles with a volume average particle diameter of 10 μm was changed from 0.12 to 0.52 parts by mass.

### Example 4

### Manufacturing of Toner 4

Toner 4 was obtained in the same manner as in Example 1 except that the zinc stearate particles with a volume average particle diameter of 10 μm was changed to zinc stearate particles with a volume average particle diameter of 3 μm.

### Example 5

### Manufacturing of Toner 5

Toner 5 was obtained in the same manner as in Example 1 except that the zinc stearate particles with a volume average particle diameter of 10 μm was changed to zinc stearate particles with a volume average particle diameter of 20 m.

### Example 6

### Manufacturing of Toner 6

Toner 6 was obtained in the same manner as in Example 1 except that, in the preparation of the aqueous phage of Example 1, 15 parts of the liquid mixture with 5 parts of the aqueous liquid dispersion (W2-1) and 10 parts of the aqueous liquid dispersion (W1-1) was changed to 15 parts of the liquid mixture with 5 parts of the aqueous liquid dispersion (W2-2) and 10 parts of the aqueous liquid dispersion (W1-2).

### Example 7

### Manufacturing of Toner 7

Toner 7 was obtained in the same manner as in Example 1 except that, in the preparation of the aqueous phage of Example 1, 15 parts of the liquid mixture with 5 parts of the aqueous liquid dispersion (W2-1) and 10 parts of the aqueous liquid dispersion (W1-1) was changed to 15 parts of the liquid mixture with 5 parts of the aqueous liquid dispersion (W2-3) and 10 parts of the aqueous liquid dispersion (W1-3).

### Comparative Example 1

### Manufacturing of Toner 8

Toner 8 was obtained in the same manner as in Example 1 except that the amount of the zinc stearate particles with a volume average particle diameter of 10 μm was changed from 0.12 to 0 parts by mass.

### Comparative Example 2

### Manufacturing of Toner 9

Toner 9 was obtained in the same manner as in Example 1 except that the amount of the zinc stearate particles with a volume average particle diameter of 10 μm was changed from 0.12 to 0.72 parts by mass.

### Comparative Example 3

### Manufacturing of Toner 10

Toner 10 was obtained in the same manner as in Example 1 except that the zinc stearate particles with a volume average particle diameter of 10 μm was changed to zinc stearate particles with a volume average particle diameter of 1.5 μm.

### Comparative Example 4

### Manufacturing of Toner 11

Toner 11 was obtained in the same manner as in Example 1 except that, in the preparation of the aqueous phage of Example 1, 15 parts of the liquid mixture with 5 parts of the aqueous liquid dispersion (W2-1) and 10 parts of the aqueous liquid dispersion (W1-1) was changed to 15 parts of the aqueous liquid dispersion (W1-2).

### Manufacturing of Developing Agent

Five parts of each toner obtained as above and 95 parts of the carrier were mixed using a ball mill to manufacture developing agents 1 to 11.

### Evaluation on Low Temperature Fixability

Each toner was uniformly deposited on a paper surface to achieve a density of 0.8 mg/cm². The method employed for depositing the powder onto the paper involved using a printer without a heat-fixing unit. If the powder could be uniformly deposited at the above-mentioned weight density, other methods were permissible.

The minimum film-forming temperature (MFT) of cold offset was measured when this paper, with the toner applied, passed through the pressure fixing roller at a fixing speed (circumferential speed of the heating roller) of 213 mm/sec and a fixing pressure (pressure of the pressure roller) of 10 kg/cm². A lower MFT of cold offset is associated with better low-temperature fixability.

### Evaluation Criteria

S: The lowest fixing temperature was lower than 130 degrees Celsius
A: The lowest fixing temperature was higher than 130 degrees Celsius to 135 degrees Celsius
B: The lowest fixing temperature was higher than 135 degrees C. to 140 degrees C.
C: The lowest fixing temperature was high than 140 degrees Celsius

### Evaluation on Temperature Storage Stability

Ten grams of the toner were filled into a 50 mL glass container, and the container was adequately tapped until there was no further change in the apparent density of the toner. The container was then sealed with a lid. After allowing the container to rest in a constant-temperature bath at 50 degrees Celsius for 24 hours, it was cooled to 24 degrees Celsius. Subsequently, the needle penetration test (JIS 2235-1991, petroleum waxes) was conducted to measure the needle penetration, and the thermal storage stability was evaluated based on the following criteria.

A higher needle penetration value indicates superior thermal storage stability. The toner is usable for practical purpose when graded B or higher.

### Evaluation Criteria

S: Penetration degree at least was 25 mm
A: Penetration degree was 20 mm to less than 25 mm
B: Penetration degree was 15 mm to less than 20 mm
C: Penetration degree was less than 15 mm

### Evaluation on Cleaning Performance

Each developing agent containing of each toner was loaded into a digital full-color multifunction machine (model: Imagio MPC5000, manufactured by Ricoh Co., Ltd.), and solid images were printed on My Paper (A4 size, manufactured by Ricoh Co., Ltd.) as a recording medium under a toner amount 1.0 mg/cm² adhered. In addition, the state after 1,000 copies made by the digital full-color multifunction machine was defined as the initial state, and the state after 100,000 copies was defined as the elapsed state. In each case, the toner remaining on the photoconductor after the cleaning process was transferred onto a blank sheet using Scotch tape (manufactured by Sumitomo 3M Co.), and the reflection density was measured using a reflection densitometer (model: RD514, manufactured by Gretag Macbeth). Based on the evaluation criteria below, the “cleanability” was evaluated.

### Evaluation Criteria

S: Difference between initial state and elapsed state is less than 0.01
A: Difference between initial state and elapsed state is 0.01 to less than 0.025
B: Difference between initial state and elapsed state is 0.025 to less than 0.05
C: Difference between initial state and elapsed state is at least 0.05

### Evaluation on Wear of Photoconductor

The film thickness of the photoconductor was measured before and after outputting 10,000 sheets of a chart having an image area coverage of 5 percent, and the amount of wear of the photoconductor was evaluated. A FISCHERSCOPE MMS, manufactured by Fischer Instruments, was used for the film-thickness measurement, and the ETA3.3H probe was employed.

### Evaluation Criteria

A: No wear of the photoconductor is present
C: Wear of the photoconductor is present

### Evaluation on Charging Stability

Using each of the obtained developing agents, a durability test was conducted in which 100,000 sheets of a text and images pattern having an image area coverage of 12 percent were continuously output, and the change in the amount of charge during the test was evaluated. A small amount of the developing agent on the sleeve was collected, and the change in charge potential was determined using the blow-off method. Evaluation was based on the following criteria:

### Evaluation Criteria

S: Change in the amount of charge is less than 2 μC/g
A: Change in the amount of charge is 2 to less than 5 μC/g
B: Change in the amount of charge is 5 to less than 10 μC/g
C: Change in the amount of charge is at least 10 μC/g

The results of Examples 1 to 7 and Comparative Examples 1 to 4 are shown in Table 2. In Examples 1 to 7 and Comparative Examples 1 to 3, fine resin particles were confirmed to be present on the surfaces of the toner base particles, as illustrated in FIG. 3. In contrast, in Comparative Example 4, fine resin particles were not observed on the surfaces of the toner base particles.

TABLE 2

| | | | Example | | | | | | |
|---|---|---|---|---|---|---|---|---|---|
| | Toner No. | | 1 | 2 | 3 | 4 | 5 | 6 | 7 |
| Toner | Zinc content | | 0.1 | 0.3 | 0.5 | 0.1 | 0.1 | 0.1 | 0.1 |
| | (percent) in toner | | | | | | | | |
| | Fine | Content | 0.045 | 0.141 | 0.25 | 0.04 | 0.045 | 0.045 | 0.045 |
| | zinc | based | | | | | | | |
| | particle | on total | | | | | | | |
| | | amount | | | | | | | |
| | | of toner | | | | | | | |
| | | Zinc | 45 | 47 | 50 | 40 | 45 | 45 | 45 |
| | | content | | | | | | | |
| | | based | | | | | | | |
| | | on total | | | | | | | |
| | | amount | | | | | | | |
| | | of toner | | | | | | | |

| | | | | | | | | |
|---|---|---|---|---|---|---|---|---|
| | Volume average | 10 | 10 | 10 | 3 | 20 | 20 | 10 |
| | particle diameter | | | | | | | |
| | (μm) of zinc | | | | | | | |
| | stearate particles | | | | | | | |
| | Volume average | 27 | 27 | 27 | 27 | 27 | 17 | 54 |
| | particle diameter | | | | | | | |
| | (μm) of fine resin | | | | | | | |
| | particle | | | | | | | |
| Evaluation | High temperature | S | S | S | S | S | S | A |
| | fixability | | | | | | | |
| | Thermal storage | S | S | S | S | S | A | S |
| | stability | | | | | | | |
| | Charge stability | S | S | S | S | S | S | S |
| | Cleaning | S | S | S | S | S | S | S |
| | performance | | | | | | | |
| | Wear of | S | S | S | S | S | S | S |
| | photoconductor | | | | | | | |

Comparative Example

| | Toner No. | 1 | 2 | 3 | 4 |
|---|---|---|---|---|---|
| Toner | Zinc content | 0 | 0.7 | 0.1 | 0.1 |
| | (percent) in toner | | | | |

| | | | | | |
|---|---|---|---|---|---|
| Fine | Content | — | 0.315 | 0.02 | 0.04 |
| zinc | based on | | | | |
| particle | total | | | | |
| | amount of | | | | |
| | toner | | | | |
| | Zinc | — | 45 | 20 | 40 |
| | content | | | | |
| | based on | | | | |
| | total | | | | |
| | amount of | | | | |
| | toner | | | | |

| | | | | | |
|---|---|---|---|---|---|
| | Volume average | — | 10 | 1.5 | 10 |
| | particle diameter | | | | |
| | (μm) of zinc stearate | | | | |
| | particles | | | | |
| | Volume average | 27 | 27 | 27 | — |
| | particle diameter | | | | |
| | (μm) of fine resin | | | | |
| | particle | | | | |
| Evaluation | High temperature | S | S | S | S |
| | fixability | | | | |
| | Thermal storage | S | S | S | C |
| | stability | | | | |
| | Charge stability | S | C | S | S |
| | Cleaning | C | S | A | A |
| | performance | | | | |
| | Wear of | C | S | C | A |
| | photoconductor | | | | |

Although embodiments of the present disclosure have been described above, the present disclosure is not limited to the specific embodiments, and various modifications and alterations may be made within the scope of the invention described in the claims.

Aspects of the embodiments of the present invention are, for example, as follows:

### Aspect 1

A toner contains a toner base particle containing a core particle that contains a binder resin, a release agent, and a colorant, and fine resin particles disposed on the surface of the core particle. and an external additive containing zinc stearate particles, wherein the content of zinc in the toner is 0.05 to 0.60 percent by mass of the toner, and the content of fine zinc particles having a particle diameter of at most 20 μm in the toner is at least 40 percent by mass of zinc in the toner.

### Aspect 2

The toner according to Aspect 1 mentioned above, wherein the content of the fine zinc particles in the toner is at least 0.03 percent by mass of the toner.

### Aspect 3

The toner according to Aspect 1 or 2 mentioned above, wherein the zinc stearate particles have a volume average particle diameter of 3 to 20 m.

### Aspect 4

The toner according to any one of Aspects 1 to 3 mentioned above, wherein the zinc stearate particles are in a scale-like form.

### Aspect 5

The toner according to any one of Aspects 1 to 4 mentioned above, wherein the fine resin particles have a volume average particle diameter of 10 to 60 nm.

### Aspect 6

A developing agent is provided which contains the toner according to any one of Aspects 1 to 5 mentioned above.

### Aspect 7

A toner accommodating unit agent is provided which includes a toner accommodating container and the toner of any one of Aspect 1 to 5 mentioned above contained in the toner accommodating unit.

### Aspect 8

An image forming apparatus is provided which includes an electrostatic latent image bearer, an electrostatic latent image forming device to form an electrostatic latent image on the electrostatic latent image bearer, and a developing device containing the toner of any one of Aspects 1 to 5 mentioned above to develop the electrostatic latent image formed on the electrostatic latent image bearer to form a visible image with the toner.

### Aspect 9

An image forming method is provided which include forming an electrostatic latent image on an electrostatic latent image bearer and developing the electrostatic latent image formed on the electrostatic latent image bearer with the toner according to any one of Aspects 1 to 5 mentioned above.

The above-described embodiments are illustrative and do not limit the present invention. Thus, numerals additional modifications and variations are possible in light of the above-teachings. For example, elements and/or features of difference illustrative embodiments may be combined with each other and/or substituted for each other within the scope of the present invention. Any one of the above-described operations may be performed in various other ways, for example, in an order difference from the one described above.

1. A toner comprising:
a toner base particle comprising:
a core particle comprising:
a binder resin;
a release agent; and
a colorant; and
fine resin particles disposed on a surface of the core particle; and
an external additive comprising zinc stearate particles,
wherein a content of zinc in the toner is 0.05 to 0.60 percent by mass of the toner, and
a content of fine zinc particles having a particle diameter of at most 20 μm in the toner is at least 40 percent by mass of zinc in the toner.

2. The toner according to claim 1,
wherein a content of the fine zinc particles in the toner is at least 0.03 percent by mass of the toner.

3. The toner according to claim 1,
wherein the zinc stearate particles have a volume average particle diameter of 3 to 20 μm.

4. The toner according to claim 1,
wherein the zinc stearate particles are in a scale-like form.

5. The toner according to claim 1,
wherein the fine resin particles have a volume average particle diameter of 10 to 60 nm.

6. A developing agent comprising:
the toner of claim 1.

7. A toner accommodating unit comprising:
a toner accommodating container; and
the toner of claim 1 contained in the toner accommodating container.

8. An image forming apparatus comprising:
an electrostatic latent image bearer;
an electrostatic latent image forming device to form an electrostatic latent image on the electrostatic latent image bearer; and
a developing device containing the toner of claim 1 to develop the electrostatic latent image formed on the electrostatic latent image bearer to form a visible image with the toner.

9. An image forming method comprising:
forming an electrostatic latent image on an electrostatic latent image bearer; and
developing the electrostatic latent image formed on the electrostatic latent image bearer with the toner of claim 1.
